(19) United States
(12) Patent Application Publication
(10) Pub. No.: US 2004/0061805 A1
(43) Pub. Date: Apr. 1, 2004

(54) Receiving apparatus, image display system and broadcasting method

(75) Inventors: Yoshikazu Shibamiya, Kanagawa (JP); Yuichi Matsumoto, Kanagawa (JP); Tomoyuki Ohno, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/667,414

(22) Filed: Sep. 23, 2003

(30) Foreign Application Priority Data
Sep. 26, 2002 (JP) 2002-281054
Sep. 17, 2003 (JP) 2003-324638

(51) Int. Cl. H04N 5/445

(52) U.S. Cl. 348/565; 348/554; 725/38

(57) ABSTRACT

The present invention discloses a receiving apparatus for receiving image data. The configuration of the receiving apparatus is disclosed. That is, the receiving apparatus includes a reception circuit for receiving first image data for displaying an image in a first display area in a maximum display area of a display apparatus, second image data for displaying an image in a second display area in the display area, and information related to image displaying in the first display area, and a control circuit for generating a signal for requesting transmission of the first image data of an apparatus for controlling the transmission of the first image data, on a basis of the information. The information is information specified by a transmitter of the second image data.

### BACKGROUND OF THE INVENTION

1. Field of the Invention

The present invention relates to a receiving apparatus, more particularly to an apparatus for receiving image data. Moreover, the present invention relates to an image display system including a receiving apparatus. Furthermore, the present invention relates to a broadcasting method.

2. Related Background Art

In recent years, compression techniques of image data and audio data have been improved, and the communication environment and the Internet environment which can perform high speed data transmission have been popularized. It has gradually become possible to distribute broadcasts such as image data and audio data through the Internet, and to view such Internet broadcasting by personal computer (hereinafter referred to as PC).

When a viewer wants to view the Internet broadcasting, the viewer first selects a connection form such as an analog modem or a local area network (LAN). After that, a stream server transmits a stream corresponding to the selected connection form to the PC of the viewer to display the stream on the PC.

On the other hand, in recent years, digital broadcasting has begun, and trials to correlate such digital broadcasting with the Internet positively have been preformed. If a digital television receiver can be used for viewing the Internet broadcasting, the utility value of the digital television is greatly improved.

As conventional techniques pertaining to the present invention, the techniques disclosed in the following documents can be cited.

For example, Patent Document 1 discloses a technique for displaying a screen by selecting the screen suitable for a display device among the screens having a plurality of pieces of resolution which are transmitted simultaneously with television broadcasting.

Moreover, Patent Document 2 discloses the following configuration. That is, in the configuration, communication management means shows a menu of proposed communication conditions of data which a transmitting apparatus can transmit under the conditions of a transmission line and the using situation of the transmitting apparatus on proposed conditions displaying means. Then, each user of a terminal apparatus selects a communication condition in the menu to instruct the transmission apparatus about the selection. After that, data transmitting means of the transmitting transmits data on the basis of the communication condition.

(Patent Document 1) Japanese Patent Application Laid-Open No. H11-13649

(Patent Document 2) Japanese Patent Application Laid-Open No. H11-32020

### SUMMARY OF THE INVENTION

The invention of the present application has an object of realizing a suitable configuration of a receiving apparatus for receiving image data. Moreover, the invention has another object of realizing a novel and useful broadcasting method.

A receiving apparatus of a present application is configured as follows.

That is, the receiving apparatus includes:

a receiving circuit for receiving first image data for displaying image data in a first display area in a maximum display area of a displaying apparatus, second image data in a second display area in the maximum display area, and information related to image display in the first display area; and

a control circuit for generating a signal requiring an apparatus for controlling transmission of the first image data to transmit the first image data on a basis of the information,

wherein the information is information specified by a transmitter of the second image data.

### BRIEF DESCRIPTION OF THE DRAWINGS

FIG. 1 is a view showing a configuration of a receiving system to which the present invention is applied;

FIG. 2 is a diagram showing a configuration of a television receiver to which the present invention is applied;

FIG. 3 is a view showing the configuration of a remote control;

FIG. 4 is an external appearance view of the remote control;

FIG. 5 is a diagram showing the configuration of a stream server;

FIG. 6 is a view showing a state of a display control table;

FIG. 7 is a view showing a state of a contents information table;

FIG. 8 is a view showing a state of a transfer mode table;

FIG. 9 is a view showing a state of a broadcasting event table;

FIG. 10 is a view showing another state of the broadcasting event table;

FIG. 11 is a view showing a display screen of the television receiver;

FIG. 12 is a view showing another display screen of the television receiver;

FIG. 13 is a view showing a state of switching the display screen according to a broadcasting event;

FIG. 14 is a view showing another state of switching the display screen according to the broadcasting event;

FIG. 15 is a view showing a further display screen of the television receiver;

FIG. 16 is comprised of FIGS. 16A and 16B showing flowcharts of a transfer mode selection procedure;

FIG. 17 is a view showing a state of transfer mode selection operation;

FIG. 18 is a view showing another state of transfer mode selection operation;

FIG. 19 is a flowchart showing broadcasting management task processing;

FIG. 20 is a flowchart showing event management task processing;

FIG. 21 is a flowchart showing broadcasting event task processing;

FIG. 22 is a flowchart showing other broadcasting event task processing;

FIG. 23 is a flowchart showing display task processing;

FIG. 24 is a view showing a state of a display control table generated by an event task;

FIG. 25 is a view showing a state of another display control table generate by another event task;

FIG. 26 is a view showing another configuration of the receiving system to which the present invention is applied;

FIG. 27 is a view showing another configuration of the television receiver to which the present invention is applied;

FIG. 28 is a view showing the configuration of a display device to which the present invention is applied;

FIG. 29 is a view showing a display screen of the television receiver;

FIG. 30 is a view showing a display screen of a display device;

FIG. 31 is a view showing a state of a display control table;

FIG. 32 is comprised of FIGS. 32A and 32B showing flowcharts of the operation of a display device control task;

FIG. 33 is a view showing a state of another display control table;

FIG. 34 is a view showing another state of the display control table; and

FIG. 35 is a view showing progress of broadcasting events.

### DESCRIPTION OF THE PREFERRED EMBODIMENTS

The invention of the present application will be described in further detail.

In the following, a receiving apparatus including the following elements will be described. That is, the receiving apparatus includes a receiving circuit for receiving image data transmitted through a network, and a control circuit for generating a signal requiring an apparatus for controlling transmission of the image data to transmit the image data in a transmission mode according to a display area in which an image based on the image information is displayed. Incidentally, each circuit constituting the receiving apparatus is not necessarily housed in a housing. Moreover, the signal for requiring the apparatus for controlling transmission to transmit the image data in the transmission mode can be transmitted to the apparatus through the same network as the network through which the image data is transmitted. However, the signal can be transmitted through other media. Incidentally, the apparatus for controlling the transmission of the image data may be the same apparatus as one for performing the transmission, or may be the apparatus different from the apparatus for performing the transmission.

Incidentally, the circuits in the present application indicate ones composed of signal paths and elements for performing predetermined processing. The circuits are not limited the ones dedicated for performing specific processing. Circuits capable of various kinds of processing and programs for making the circuits perform specific processing may be used in a combined state. As the elements mentioned above, the elements such as resistors, capacitors, transistors and the like can be used in the case where the signals to be processed are electric signals.

Moreover, the control circuit may be configured to select the transmission mode among a plurality of transmission modes having different transmission speeds, and to generates a signal for requesting transmitting the image data in the selected transmission mode. Moreover, it is suitable that the control circuit selects a transmission mode having a transmission speed lower than that of a maximum reception speed which the reception circuit can receive through the network among the plurality of transmission modes.

Moreover, it is suitable that the image data includes data for displaying a series of images, and what the plurality of transfer modes includes at least a plurality of transfer mode in which frame rates of the series of images are different from each other.

Moreover, the configuration can be suitably adopted in which the plurality of transfer modes includes a first mode and a second mode, the first mode being a mode in which resolution of an image to be displayed on a basis of data transmitted in the first mode is recognized to be higher than resolution of an image to be displayed on a basis of data transmitted in the second mode. The configuration can be suitably adopted in which the image data includes data for displaying a series of images, and the plurality of transfer modes includes a first mode and a second mode, the second mode being a mode in which visibility of a movement of an object in a series of images displayed on a basis of data transmitted in the second mode is higher than visibility of a movement of an object in a series of images displayed on a basis of data transmitted in the first mode. Which of the first mode and the second mode should be selected can be determined on the basis of the genre of the image displayed on the received image data and the kinds of display apparatus.

Moreover, the configuration can be suitably adopted in which the reception circuit receives transmission mode information including at least information of a plurality of transmission modes which an apparatus for performing transmission of the image data can transmit. The transmission mode information may be the information transmitted through the network, or may be the information transmitted through the other media. Moreover, the apparatus for transmitting the transmission mode information may be the same thing as the apparatus, for transmitting the image data, or may be a thing different from the apparatus. The circuit for receiving the transmission mode information may be different circuit from the circuit for receiving the image data through the network, or may be the same circuit as the latter circuit. It is suitable that, when the transmission mode information is input through a different medium from the network, different circuits are severally used. In this case, the reception circuit includes the different circuits. When the different circuits are located distantly from each other, a circuit including the different circuits is generally called as the reception circuit.

Moreover, it is suitable to configure the output circuit so as to include a buffer memory for storing the image data received by the reception circuit, and to change an amount of data to be stored in the buffer memory according to the transmission mode in which the transmission is requested to be performed.

Moreover, it is suitable that the reception circuit receives a signal specifying the size of the display area in which the image based on the image data is displayed. The circuit for receiving the signal for specifying the size of the display area in which the image based on the image data is displayed may be a different circuit from the circuit for receiving the image data transmitted through the network, or may be the same circuit as the latter circuit. It is suitable that, when the signal for specifying the size of the display area for displaying the image based on the image data is input through a medium different from the network, different circuits are used. In this case, the reception circuit includes the different circuits. When the different circuits are located distantly from each other, a circuit including the different circuits is generally called as the reception circuit.

Moreover, the size of the display area is not limited to the absolute size (the magnitude having the units of a length and an area). For example, when the size of the display area is specified by means of a predetermined number of pixels, the absolute size of the display area differs according to the pixel pitches. Moreover, when the size of the area in which the image based on the image data is displayed is specified by the use of the maximum displayable area in the display apparatus or a comparison condition such as a rate to another display area or the like, the absolute size of the area in which the image based on the image data is displayed is determined according to the absolute size of the area to be the object of the comparison.

Moreover, the configuration can be suitably adopted in which the control circuit performs control in order that images may be displayed in a plurality of display areas severally, the display areas including at least a first display area being the display area in which the image based on the image data is displayed and a second display area different from the first display area, a size of the first display area determined on a basis of designation made by a transmitter of image data for displaying an image in the second display area. The circuit for controlling the receiving apparatus to display the image in the plurality of areas may be the same circuit as the circuit for generating the signal for requesting the transmission of the image data in the transmission mode according to the size of the display area, or may be the different circuit from the latter circuit. When they are different circuits, a circuit including them is generally called as the control circuit.

Incidentally, the outer periphery of one of the plurality of display areas may coincide with the outer periphery of the maximum display area of the display apparatus. In addition, each display area is not limited to a rectangle.

Moreover, the transmitter of the image data for displaying the image in the second display area includes a manufacturer of the image data for displaying the image in the second image area, a transmitter of the image data for displaying the image in the second image area, an director of the transmission of the image data for displaying the image in the second display area, a requester requesting the transmission of the image data for displaying the image in the second display area, and the like. The specification by the transmitter can be performed by means of a signal transmitted together with the image data for displaying the image in the second display area, or a signal to be transmitted independently from the image data as the information related to the image data.

Moreover, the configuration can be suitably adopted in which the control circuit performs control in order that images may be displayed in a plurality of display areas severally, the display areas including at least a first display area being the display area in which the image based on the image data is displayed and a second display area different from the first display area, and the image data for displaying the image in the first display area is image data specified by a transmitter of image data for displaying an image in the second display area.

Moreover, in particular, the configuration in which the receiving apparatus displays a television broadcast in the second display area can be suitably adopted. The configuration in which the receiving apparatus displays a stream broadcast in the first display area can be suitably adopted.

Preferably, the receiving apparatus includes a tuner for performing the reception of television broadcasting. However, the receiving apparatus may be configured to be able to receive a signal from a tuner provided independently from the receiving apparatus.

Moreover, the configuration can be suitably adopted in which the reception circuit receives information related to time when the size of the display area in which the image is displayed is changed, and the control circuit changes the transmission mode requested to the apparatus for controlling the transmission on a basis of the information related to the time.

Moreover, the receiving apparatus may have the display apparatus built-in. Moreover, the receiving apparatus may be provided as an independent body from the display apparatus.

Moreover, the present invention includes the invention of a receiving apparatus, comprising: a reception circuit for receiving first image data for displaying an image in a first display area in a maximum display area of a display apparatus, second image data for displaying an image in a second display area in the display area, and information related to image displaying in the first display area; and a control circuit for generating a signal for requesting transmission of the first image data of an apparatus for controlling the transmission of the first image data, on a basis of the information which is information specified by a transmitter of the second image data. The embodiment of the invention will be described later.

Hereupon, the outer periphery of one of the first display area and the second display area may coincide with the outer periphery of the maximum display area of the display apparatus.

Moreover, the configuration in which the information includes at least information indicating a size of the first display area can be suitably adopted. The information indicating the size of the first display area is not necessarily the size of the display area itself (i.e. is not limited to the absolute size), but the information may be the information which can specify the size of the display area by processing the information. Moreover, the configuration can be suitably adopted in which the first image data is data for displaying a series of images, and the information includes at least information indicating a frame rate of the series of images. The information indicating a frame rate is not necessarily the frame rate itself, but the information may be the information which can specify the frame rate by processing the information. The frame rate indicates the number of images displayed for a unit period of time. Moreover, the series of images in the present application includes a series of images formed by the data for interlace displaying. Moreover, the configuration in which the information includes at least information specifying the first image data can be suitably adopted. As the information for specifying the first image data, the information indicating the address of the first image data can be suitably adopted. Moreover, the configuration in which the information includes at least information related to time to start or to end displaying based in the first image data can be suitably adopted. Moreover, the configuration in which the information includes at least information related to time when a size of the first display area is changed can be suitably adopted. The information related to time may be the information for specifying time, or the information for specifying the time elapsed from the predetermined time.

Incidentally, the configuration in which the first image data and the second image data are received by the receiving apparatus through different paths can be suitably adopted.

In the following, an embodiment including the receiving apparatus described above and a transmitting apparatus for transmitting at least one of pieces of the image data is described. The receiving apparatus and the image data constitute an image display system.

Moreover, the following embodiment relates to a broadcasting method for broadcasting a program to a receiving apparatus. The following embodiment is also an embodiment of the invention of a broadcasting method comprising the steps of: transmitting the program in order that the receiving apparatus can receive the program; and transmitting information for displaying an image related to the program as a display screen different from a display screen in which a display apparatus for displaying the program displays the program. As the program, programs having various configurations can be adopted. The program includes a commercial. Moreover, the information may include at least information for specifying image data for displaying the image related to the program, or may include at least information for specifying a displaying size of the image related to the program with the display apparatus, or further may include at least information related to time to start or to end displaying of the image related to the program.

(First Embodiment)

In the following, a first embodiment of the present invention will be described by reference to the attached drawings.

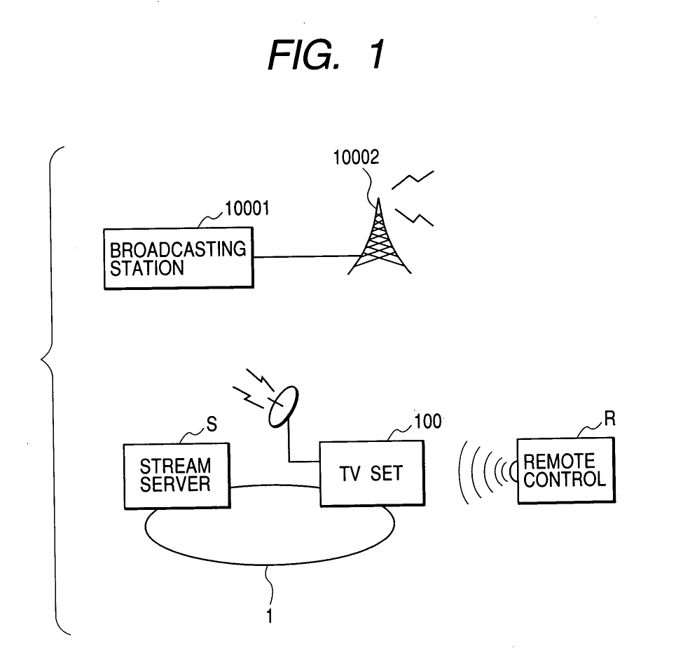

FIG. 1 is a block diagram showing the configuration of the receiving system according to the present embodiment.

In FIG. 1, a reference numeral 10001 designates a television broadcasting station. A reference numeral 10002 designates a transmitting facility including a transmitting apparatus for broadcasting television programs. A reference numeral 100 designates a television receiver having a reception function of stream broadcasts from a stream server connected to the television receiver 100 through the Internet in addition to the function of receiving usual digital television broadcasts. Moreover, the television receiver 100 receives commands from a remote control R.

A reference letter S designates a stream server connected to the Internet I. The stream server S delivers stream broadcasting data to the television receiver 100 through the Internet I. The reference letter I designates the so-called Internet network, to which communication apparatus such as various servers and the like in all the world are connected. The receiver 100 performs the transmission and the reception of data among various apparatus in addition to the stream server S through the Internet.

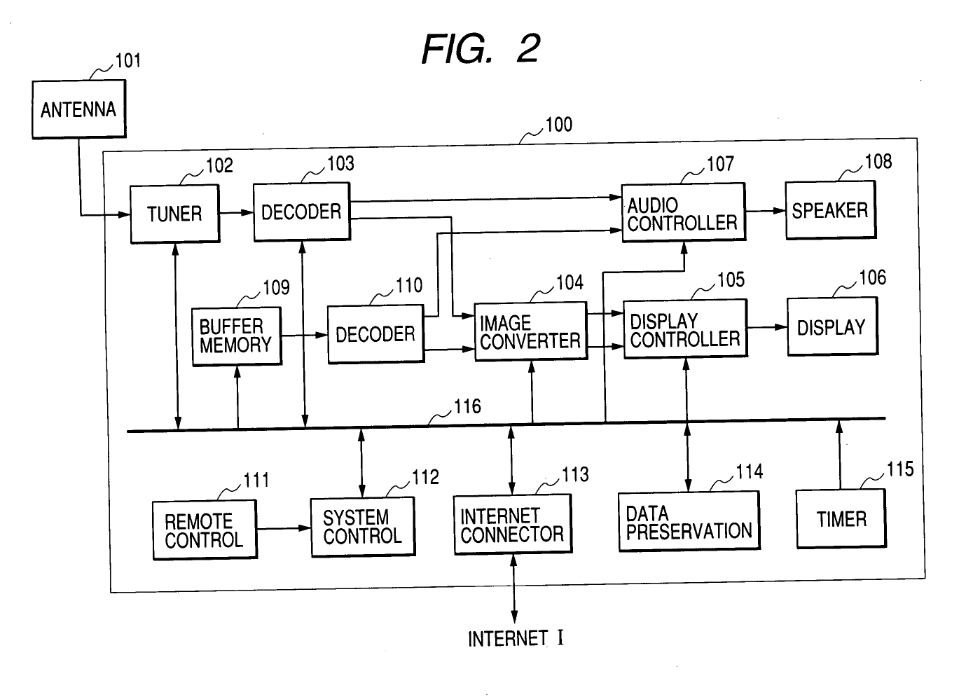

FIG. 2 is a diagram showing the configuration of the television receiver 100.

In FIG. 2, a reference numeral 101 designates an antenna, which receives digital television broadcasting waves. A reference numeral 102 designates a tuner. The tuner 102 amplifies the signals of the received digital television broadcasting, and demodulates the amplified signals, and further separates the image signals and the audio signals of a desired channel from the data of data broadcasting and information data related to the broadcasting such as event data and the like. The tuner 102 outputs the separated image signals and the separated audio signals to a decoder 103. The tuner 102 outputs the other data to a system control 102 and data preservation 114 through a bus 116. The reference numeral 103 designates the decoder. The decoder 103 decodes the image signals and the audio signals which are output from the tuner 102, and outputs the decoded image signals and the decoded sound signals to an image converter 104.

The reference numeral 104 designates the image converter. The image converter 104 performs various kinds of conversion processing such as enlargement/reduction, the conversion of frame rates, and the like of image data output through the decoder 103, the decoder 110 and the bus 116. The image converter 104 outputs the converted image data to a display controller 105. The reference numeral 105 designates the display controller. The display controller 105 switches various image data from the image converter 104 in accordance with the control of the system control 102 to output the switched image data to a display 106 so as to display the switched image data at predetermined positions. The display controller 105 further synthesizes various pieces of information to output the synthesized information in accordance with the system controller 112. The reference numeral 106 designates the display for displaying image data from the display controller 105. In the present embodiment, as the display 106, a plasma display device having the resolution of 1300 pixels in the horizontal direction×1100 pixels in the vertical direction and a size of 50 inches is used. A reference numeral 107 designates a audio controller. The audio controller 107 outputs audio data from the decoder 110 to a speaker 108 in conformity with directions from the system control 112.

A reference numeral 113 designates an Internet connector. As shown in FIG. 1, the Internet connector 113 is connected to the Internet I. Incidentally, the maximum data transferable speed at which the Internet connector 113 can perform transmission and reception is 2 Mbps in the present embodiment.

A reference numeral 109 designates a buffer memory. The buffer memory 109 stores a predetermined quantity of the data of stream broadcasts received at the Internet connector 113, and outputs the data to the decoder 110. The buffer memory 109 is a first in first out (FIFO) memory, and the size thereof may be changed. The reference numeral 110 designates the decoder. The decoder 110 decodes stream broadcast data received at the Internet connector 113 and stored in the buffer memory 109, and outputs the decoded data to the image converter 104 and the audio controller 107 as image data and audio data.

A reference numeral 111 designates a remote control. The remote control 111 receives an infrared command which is output when a user operates the remote control R, and outputs the received infrared command to the system control 112.

The reference numeral 114 designates the data preservation. The data preservation 114 stores electronic program guide (EPG) data and broadcasting information data such as broadcasting event table, which will be described later, and the like in the data received with the tuner 102; the Internet data, such as contents information table and the like, received at the Internet connector 113; and control information data such as a display control table, which will be described later, and the like.

A reference numeral 115 designates a timer. The timer 115 measures seconds in addition to minutes, hours and dates. The timer 115 is used for the starting of display of the time preengaged for viewing, the detection of starting times of various events, and the like.

The reference numeral 112 designates the system control. The system control 112 unificatory controls each section of the television receiver 100. The system control 112 is composed of a central processing unit (CPU), a main storage, a bus controller, a program storage unit, a parameter storage unit, and the like. Moreover, in the reception of a television broadcast, the system control 112 switches the reception channel of the tuner 102 in accordance with directions from the remote control R to perform an accounting control, the control of information data analysis such as EPG data, broadcasting event table and the like, and the like. Moreover, the system control 112 controls the image converter 104 and display controller 105 by means of the display control table for controlling display images to the display 106.

FIG. 6 is a view showing an example of the display control table. In the display table, the following input information which is necessary for displaying, output information to the display, and display time information are described. The input information concerns an input source, input resolution, a frame rate, the number of colors, and the like. The output information concerns resolution, X and Y display positions, a z position (priority relations with the other screens), and the like. The display time information concerns a display start time, a display time and the like. The table is produced by each task (program) requiring displaying, and is adjusted and displayed by the display tasks.

Moreover, the system control 112 similarly controls the audio controller 107 to output audio data from the decoder 103 to the speaker 108.

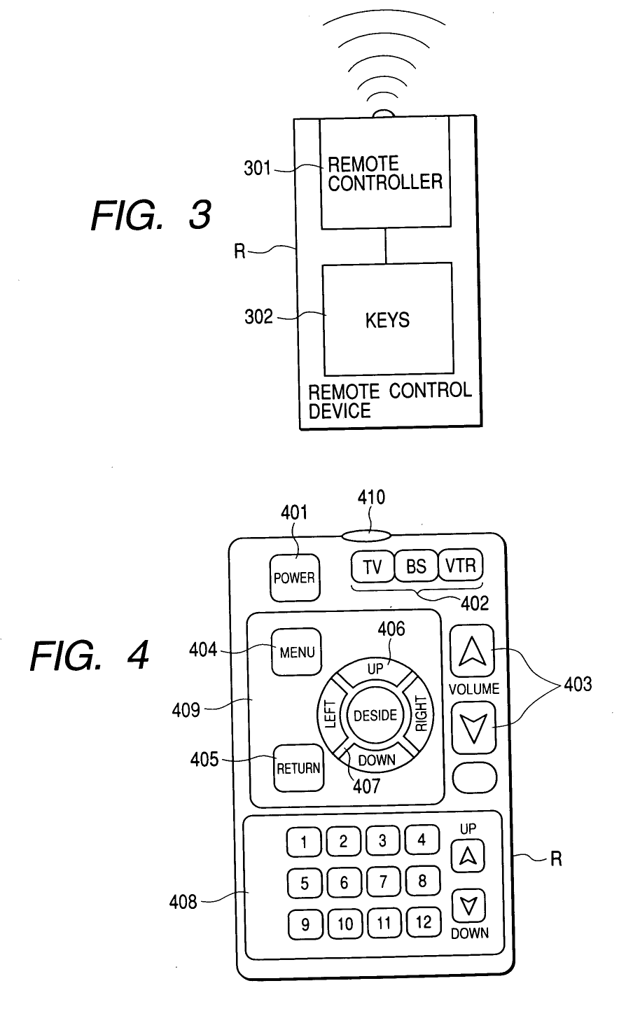

FIG. 3 is a block diagram showing the configuration of the remote control R.

In FIG. 3, a reference numeral 301 designates a remote controller. The remote controller 301 transmits remote control key data, which is output according to the operations of keys 302, as infrared signals. The reference numeral 302 designates the keys. The keys 302 include various operation keys as shown in FIG. 4.

FIG. 4 is the external appearance view of the remote control R.

In FIG. 4, the remote control R includes a power key 401, a key group 402 for switching input sources, volume keys 403, a menu key 404, a return key 405, left, right, up and down cursor keys 406, a decision key 407, channel keys 408 and an infrared ray transmitter 410. A user operates a key group 409 composed of the menu key 404, the return key 405, the left, the right, the up and the down cursor keys 406, and the decision key 407, and thereby executes a desired apparatus operation and a desired apparatus control.

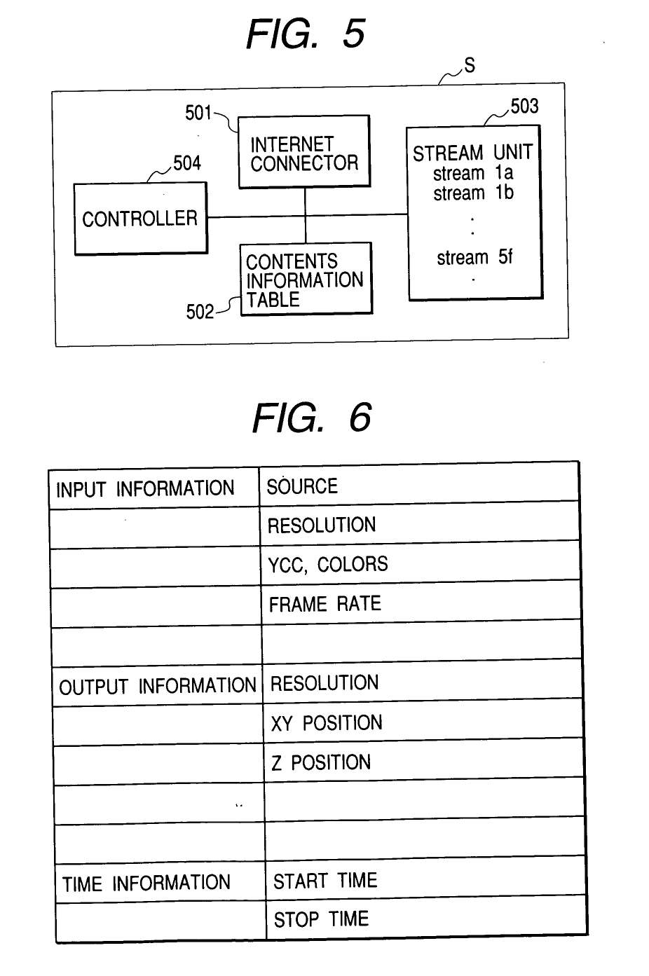

FIG. 5 is a diagram showing the configuration of the stream server S.

In FIG. 5, a reference numeral 501 designates an Internet connector connected to the Internet I. Then, the Internet connector 501 transmits control information from a contents information table unit 502 and stream broadcasting data from a stream unit 503 to the television receiver 100 through the Internet I in accordance with the control of a controller 504.

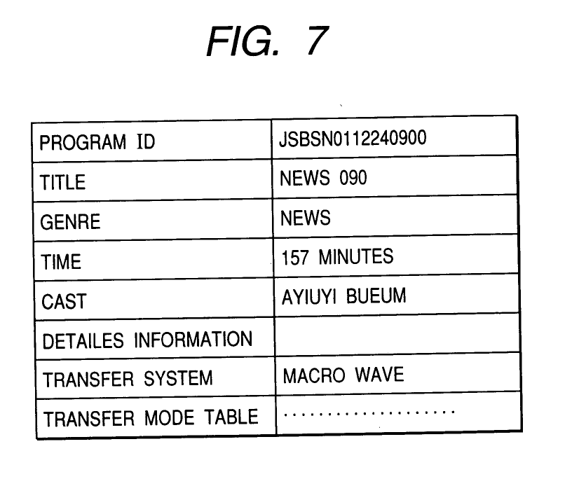

The reference numeral 502 designates the contents information table unit. The contents information table unit 502 stores a contents information table describing the information of the programs in the stream server S. FIG. 7 shows the contents of the contents information table.

As shown in FIG. 7, the contents information table stores a transfer mode table at every program in addition to program identification data (ID), a program title, a genre, a broadcasting time and a cast which specify a program. The transfer mode table is a table showing the combination of the resolution of stream data which the stream server S can output, a frame rate and the like. The table also shows a transfer speed. The Internet connector 501 transmits the contents information table including the transfer mode table to the receiver 100.

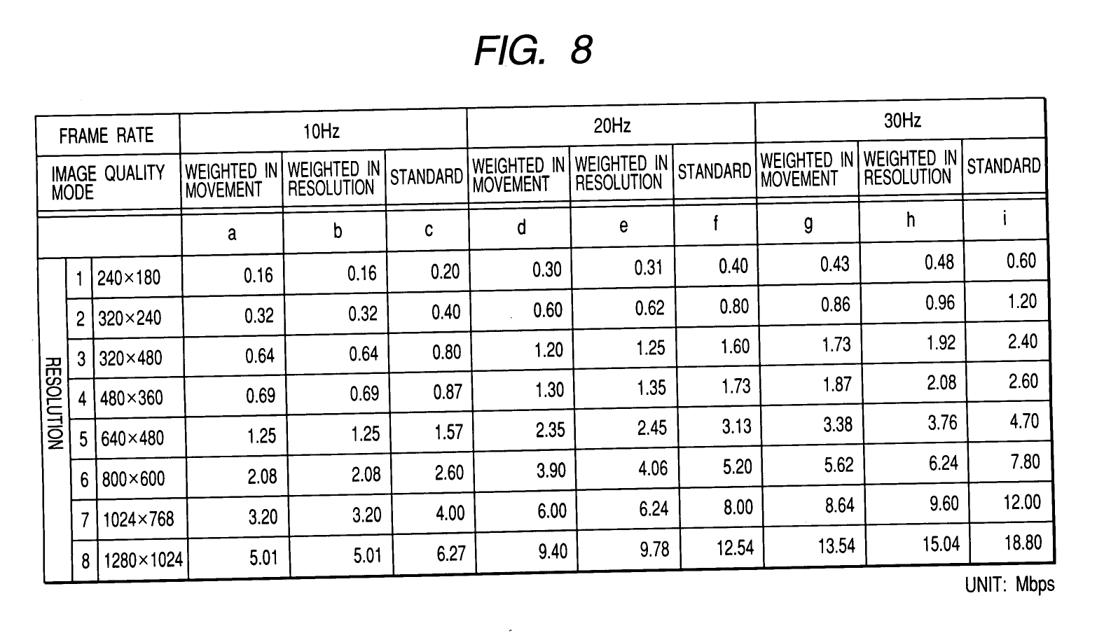

FIG. 8 shows an example of the transfer mode table. As shown in FIG. 8, at a lower right position of the transfer mode table, the original data rate of a stream is shown, and at the other part, data rates the amount of the information of which is decreased by the compression coding, the frame thinning, the resolution conversion and the like of the original stream data are shown.

In the example of FIG. 8, the size of the original contents data is 1280 pixels×1024 pixels, and the frame rate of the original contents data is 30 Hz. In the present embodiment, a plurality of data generated by decreasing the resolution and the frame rate of the original contents data is prepared to be stored in the stream unit 503. Moreover, the present embodiment is provided with a weighted in movement mode, a weighted in resolution mode and a standard mode which is located between the former two modes. Each of the modes has the same frame rate and the same resolution corresponding to the size of a display area, but each has different resolution feeling and different follow-up feeling to the movements of objects in displayed images. The different feeling is produced by changing the compression rate of each of the modes.

Next, the detailed operation of the present embodiment at the time of receiving stream broadcasting will be described.

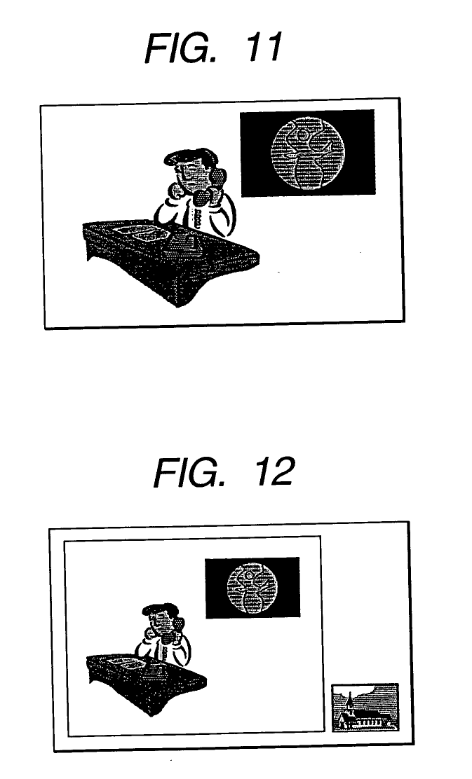

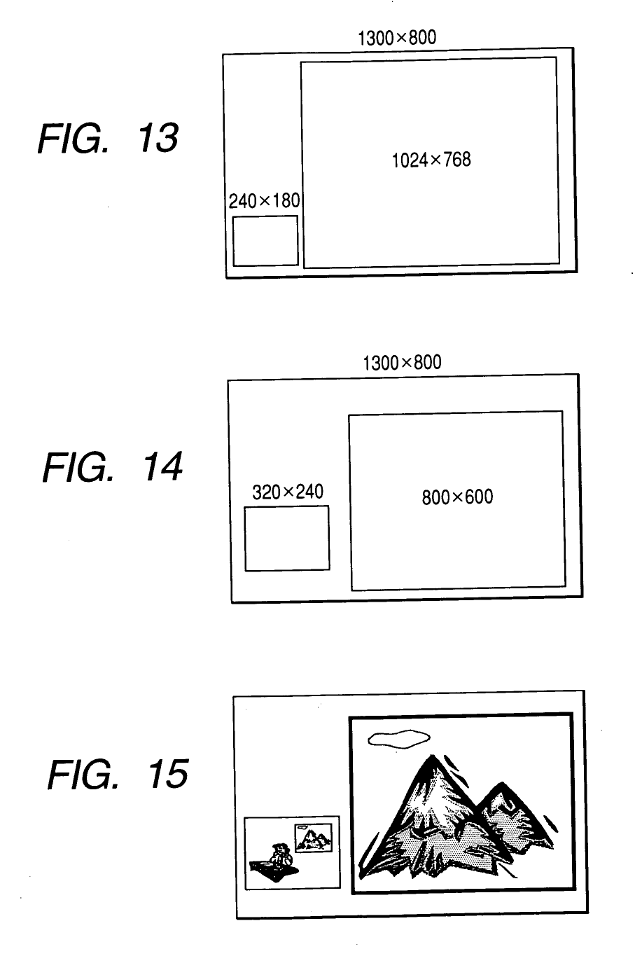

In the present embodiment, the following case will be described as an operation example. That is, in the case, a user first starts to view a television broadcasting program by displaying the program on the whole screen of the display 106 as shown in FIG. 11. After that, when the time becomes tDS1, the screen of the display 106 is switched to display two screens of a larger one and a smaller one as shown in FIG. 12 by a broadcasting event 1 controlled by a broadcasting station. A stream broadcasting program received through the Internet is displayed on a subsidiary screen, the smaller screen. Moreover, when the time becomes tDS2, the size relation between the display screens is inverted as shown in FIGS. 13 and 14 by a broadcasting event 2 from the broadcasting station. The state of the transition is shown in FIG. 35. Incidentally, it is supposed that the display mode of the program viewed as shown in FIG. 11 is an interlace mode having the resolution of 1280 pixels×1024 pixels and the frame rate of 60 Hz.

The operation mentioned above progresses in the following procedure.

1. the start of the view of a television broadcasting program by a user (the start of a television broadcasting program display task)

2. the start of the reception of a broadcast including events (the display of the whole screen as shown in FIG. 11)

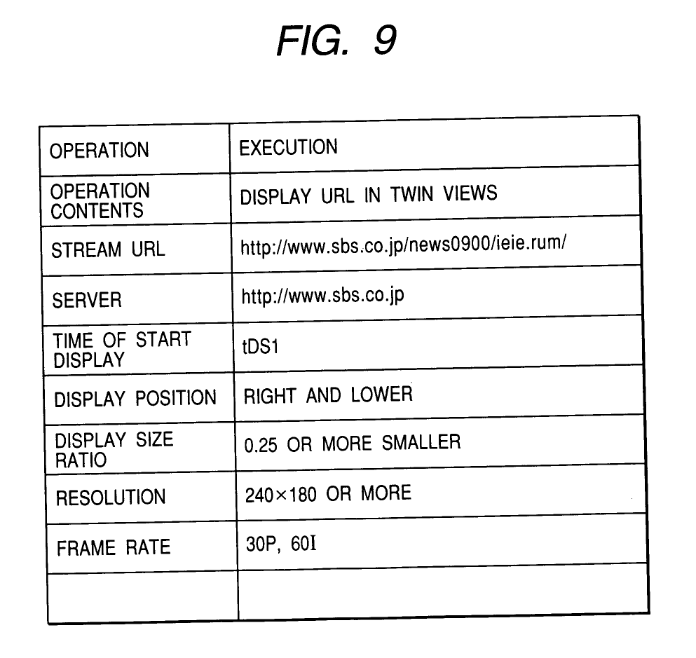

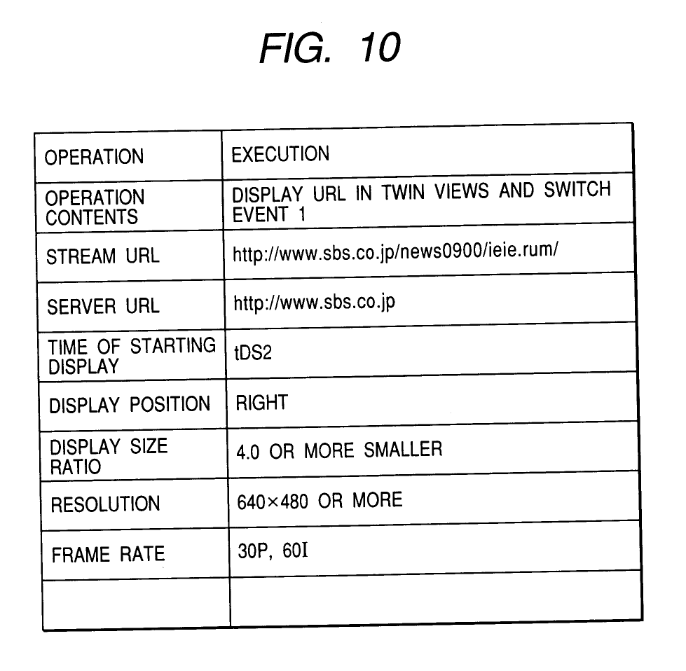

3. the start of a broadcasting management task (the detection of the event tables shown in FIGS. 9 and 10, the analysis of the detected event tables, the detection of stream reception from each event, the decision of a transfer mode, and the decision of event starting time tBS1 and tBS2)

4. the start of an event management task (the start of each event at the event starting time tBS1 and tBS2)

5. the start of the event task of the broadcasting event 1 (the reception of a stream broadcast in a transfer mode 2i, display at the display start time tDS1, and the display of the larger screen and the smaller screen in FIG. 12)

6. the start of the event task of the broadcasting event 2 (the reception of a stream broadcast in a transfer mode 5c, display at the display start time tDS2, and the display of a larger screen and a smaller screen, which are inverted in size relation, in FIG. 15)

Next, the operation of each task will be described. Incidentally, the reception task and the display task (the items 1 and 2) are the control processing of the reception, the display and the channel switching of ordinary television broadcasting programs, and they are not directly related to the contents of the present invention. Accordingly, the descriptions of the reception task and the display task are omitted.

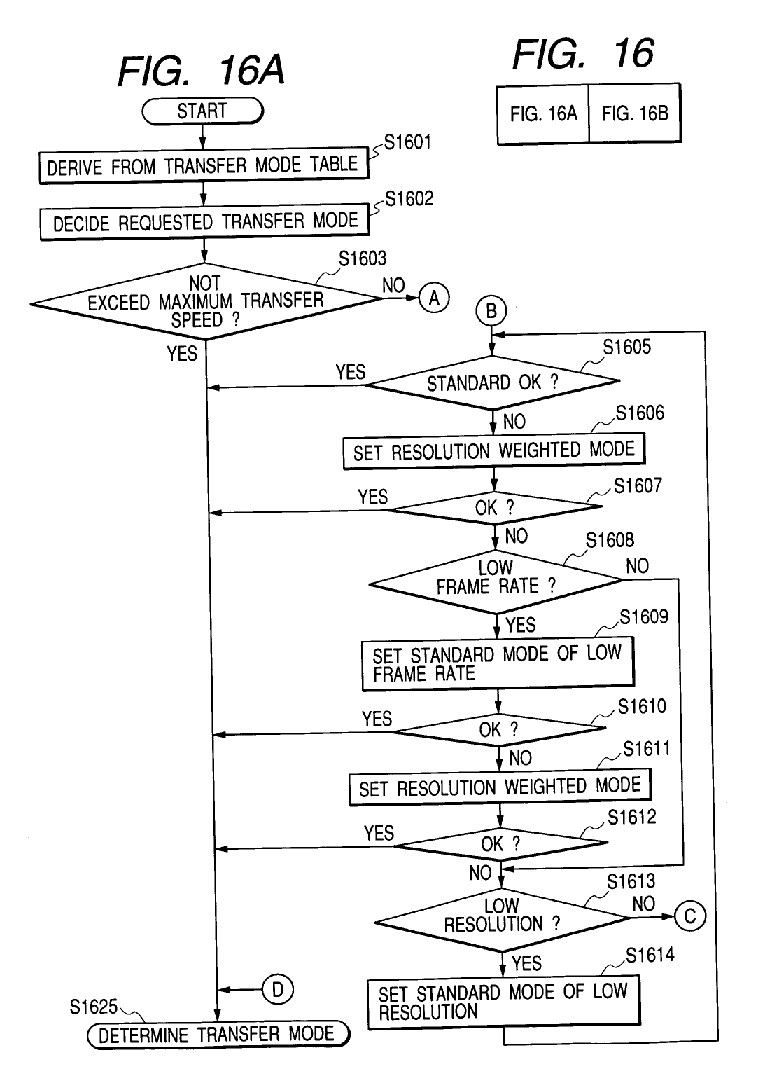

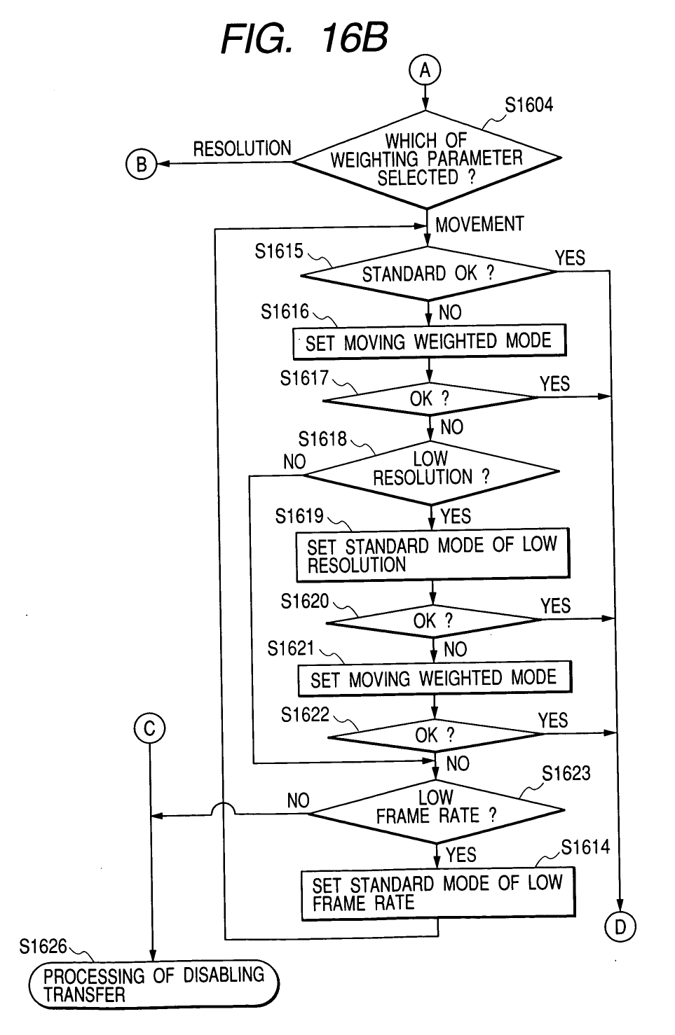

First, the decision processing of a transfer mode at the time of the reception of a stream in the broadcasting management task (the item 3). FIGS. 16A and 16B are flowcharts showing the decision processing of the transfer mode by the system control 112.

When the broadcasting station 10001 broadcasts a program, the broadcasting station 10001 transmits the information for displaying another screen in liaison with the display of the program in addition to the program. The information includes the uniform resource locator (URL) of the image data to be displayed on the other screen and the address of the server storing the image data as the information for specifying the image data. The information further includes the information of the time at which the display of the other screen is started, the information indicating the position in the maximum display area of the display 106 where the other screen is displayed, the information indicating the ratio between the display size of the other screen and the display size of the display screen, the information indicating the size of the display area of the other screen, and the frame rate information of a series of images to be displayed on the other screen. It is the broadcasting event tables shown in FIGS. 9 and 10 that show the contents of the information. The receiver 100 receives a stream broadcasting program (image data) through the Internet on the basis of the broadcasting event table at the time of displaying the program, and performs the display in the area in which the program is displayed and the display in the area in which the other screen is displayed, severally, in accordance with the specification of the broadcasting event table.

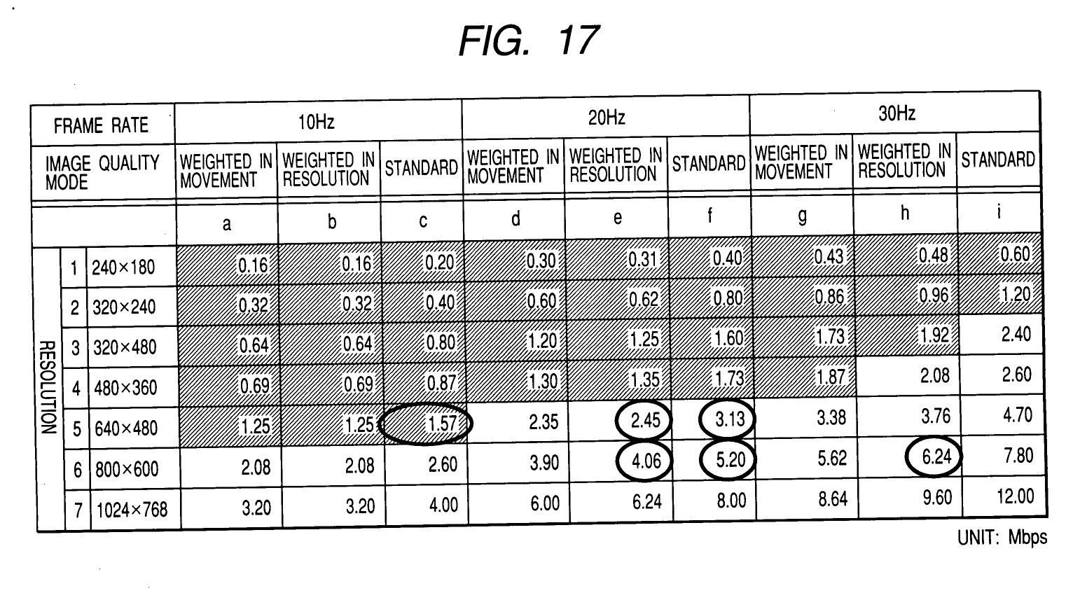

First, when a stream broadcasting program is received by the receiver 100, the system control section 112 controls the Internet connector 113 to require a contents information table to the stream server S, and receives the contents information table from the stream server S. The system control section 112 stores the received contents information table in the data preservation 114. The state of the selection processing of the contents information table of the present embodiment is shown in FIG. 17.

Then, the system control section 112 derives a transfer mode having a transfer speed within the range of the maximum transfer speed at which the receiver 100 can receive the stream data of the stream broadcasts. Because the maximum transfer speed is 2 Mbs in the present embodiment as mentioned above, the modes shown in the hatched columns of FIG. 17 are derived (Step S1601).

Next, the system control section 112 decides a provisional requested transfer mode (resolution, frame rate) being a starting point of the process for deciding a transfer mode (transmission mode) to be requested to the apparatus controlling the transmission of the stream broadcasts (Step S1602). The provisional requested transfer mode is decided by specification and requirement by a user or by a broadcasting event. But, there is the case where the requested transfer mode is limited by the resolution and the frame rate of the display 106 and the resolution and the frame rate of the stream broadcasting data to be transmitted.

For example, when there are no transfer modes satisfying the request in the transfer mode table, the system control section 112 selects a transfer mode having resolution nearest to the resolution requested by the event (or the user) on the supposition of enlargement display (for example, the case where the maximum resolution of the selectable transfer modes is 800 pixels×600 pixels to the resolution of 1024 pixels×768 pixels which is requested by the broadcasting event) or reduction display (for example, the case where the minimum resolution of the selectable transfer modes is 640 pixels×480 pixels to the resolution of 320 pixels×240 pixels which is requested by the broadcasting event)

Moreover, the situation is also applied to the case where an event requirement is not satisfied owing to the limitation of the resolution or the like of the display 106. For example, the best condition in FIG. 17 among the required transfer modes meeting the condition (640 pixels×480 pixels) specified by the broadcasting event 2 shown in FIG. 10 is the mode having the resolution of 1024 pixels×768 pixels and the frame rate of 30 Hz. This condition is within the range of the size of the maximum displayable area (1300 pixels×110 pixels). As it will be described later, the displayable size of the other screen, namely the size of the other screen in which images can be displayed without interfering with the display area in which television programs are displayed, is the size of the resolution of 800 pixels×600 pixels. Consequently, the image data exceeding the resolution is not necessary to be received. Accordingly, the resolution is set to be the resolution of the provisional requested transfer mode. The frame rate of the provisional requested transfer mode is set to be 30 Hz, which is the maximum frame rate meeting the specified condition (5P, 10I or more) by the broadcasting station side.

Next, the system control 112 judges whether the provisional requested transfer mode exceeds the maximum transfer speed of the receiver 100 or not (Step S1603). When the provisional requested transfer mode does not exceed the maximum transfer speed, it is possible to transfer stream broadcasting data at the provisional requested transfer mode. Accordingly, the provisional requested transfer mode is determined to be a transfer mode (Step S1625).

On the other hand, when the provisional requested transfer mode exceeds the maximum transfer speed, a transfer mode having a transfer speed lower than the maximum transfer speed should be selected.

Then, when the transfer mode having the lower transfer speed is selected, it is first determined which one of resolution feeling and movement is weighted. In the present embodiment, which one of the resolution feeling and the movement is weighted is automatically determined on the basis of the genre of an input program, an output program, the kind of a display device and the like.

For example, when the genre of a stream broadcast to be received is a sport, the movement thereof is weighted. When the genre of a stream broadcast to be received is a program of journey, the resolution thereof is weighted. Otherwise, when the display device is a cathode ray tube (CRT), movement is weighted. When the display device is a liquid crystal display (LCD), resolution is weighted.

Hereupon, it is judged that the transferable speed of the receiver 100 is low to be 2 Mbps to the requested transfer mode, and that, when resolution is set to be too much lower, image deterioration at the time of enlargement display becomes large. Accordingly, it is supposed that resolution is selected to be weighted (Step S1604).

Next, the case where a selection procedure weighted in resolution is selected will be described.

First, the procedure starts in a standard mode of a provisional requested transfer mode. When the transfer speed of the provisional requested transfer mode does not exceed the maximum transfer speed, the system control 112 determines the standard mode as the transfer mode and ends the procedure (Steps S1605 and S1625). When the transfer speed of the provisional requested transfer mode exceeds the maximum transfer speed, the system control 112 examines the transfer speed of a mode weighted in resolution having the same resolution (Step S1606) to judge whether the transfer speed exceeds the maximum transfer speed or not (Step S1607). When the transfer speed does not exceed the maximum transfer speed, the system control 112 determines the transfer mode having the transfer speed as the transfer mode, and ends the decision processing of the transfer mode.

When the transfer speed exceeds the maximum transfer speed, the system control 112 examines the existence of modes having lower frame rates. When the modes having the lower frame rates exist, the system control 112 shifts to a standard mode having a frame rage lower than that of the previous standard mode by one rank (Step S1609). Then, the system control 112 judges whether the transfer speed of the mode exceeds the maximum transfer speed or not (Step S1610). When the transfer speed does not exceed the maximum transfer speed of the apparatus, the system control 112 determines the transfer mode having the transfer speed as the transfer mode, and ends the decision processing of the transfer mode.

Moreover, when there are no modes having lower frame rates, the system control 112 examines the existence of modes having lower resolution (Step S1613). When there are no modes having the lower resolution also, the system control 112 performs the processing of disabling transfer (Step S1626) because there are no transfer modes in which reception can be performed.

When the transfer speed of the standard mode having the frame rate lower by one rank exceeds the maximum transfer speed at Step S1610, the system control 112 examines the transfer speed of a mode weighted in resolution having the same resolution (Step S1611) to judge whether the transfer speed exceeds the maximum transfer speed or not (Step S1612). When the transfer speed does not exceed the maximum transfer speed, the system control 112 determines the transfer mode having the transfer speed as the transfer mode, and ends the decision processing of the transfer mode.

When the transfer speed exceeds the maximum transfer speed, the system control 112 examines the existence of modes having lower resolution (Step S1613). When the modes having the lower resolution exist, the system control 112 shifts to a standard mode having resolution lower than that of the previous standard mode by one rank (Step S1614). Then, the decision processing of the transfer mode returns to Step S1605.

On the other hand, when a selection procedure weighted in movement is selected at Step S1604, the procedure first starts in a standard mode of a provisional requested transfer mode. When the transfer speed of the provisional requested transfer mode does not exceed the maximum transfer speed, the system control 112 determines the standard mode as the transfer mode and ends the procedure (Steps S1615 and S1625).

When the transfer speed of the provisional requested transfer mode exceeds the maximum transfer speed, the system control 112 examines the transfer speed of a mode weighted in movement having the same resolution (Step S1616) to judge whether the transfer speed exceeds the maximum transfer speed or not (Step S1617). When the transfer speed does not exceed the maximum transfer speed, the system control 112 determines the transfer mode having the transfer speed as the transfer mode, and ends the decision processing of the transfer mode. When the transfer speed exceeds the maximum transfer speed, the system control 112 examines the existence of modes having lower resolution (Step S1618). When the modes having the lower resolution exist, the system control 112 shifts to a standard mode having resolution lower than that of the previous standard mode by one rank (Step S1619). Then, the system control 112 judges whether the transfer speed of the mode exceeds the maximum transfer speed or not (Step S1620). When the transfer speed does not exceed the maximum transfer speed, the system control 112 determines the transfer mode having the transfer speed as the transfer mode, and ends the decision processing of the transfer mode.

Moreover, when there are no modes having lower resolution, the system control 112 examines the existence of modes having lower frame rates (Step S1623). When there are no modes having the lower frame rates also, the system control 112 performs the processing of disabling transfer because there are no transfer modes in which reception can be performed.

When the transfer speed of the standard mode having the resolution lower by one rank exceeds the maximum transfer speed at Step S1618, the system control 112 examines the transfer speed of a mode weighted in movement having the same resolution (Step S1621) to judge whether the transfer speed exceeds the maximum transfer speed or not (Step S1622). When the transfer speed does not exceed the maximum transfer speed, the system control 112 determines the transfer mode having the transfer speed as the transfer mode, and ends the decision processing of the transfer mode.

When the transfer speed exceeds the maximum transfer speed, then the system control 112 examines the existence of modes having lower frame rates (Step S1623). When the modes having the lower frame rates exist, the system control 112 shifts to a standard mode having a frame rate lower than that of the previous standard mode by one rank (Step S1624). Then, the decision processing of the transfer mode returns to Step S1615.

By performing such processing, the system control 112 determines final transfer mode, or determines the processing of disabling transfer.

In FIG. 17, when a transfer mode having the resolution of 800 pixels×600 pixels and the frame rate of 30 Hz is selected as the provisional requested transfer mode and the processing shown in FIGS. 16A and 16B are executed in the mode weighted in resolution, the modes enclosed by circles indicate the transfer modes which are examined on the way of decision.

In this case, the determination procedure starts from the standard mode (6i) having the resolution of 800 pixels×600 pixels, and examines the modes in the order of 6i→6h→6f→6e→5f→5e→5c. Finally, the transfer mode is determined to be the transfer mode 5c having the resolution of 640 pixels×480 pixels, the frame rate of 10 Hz, and the transfer speed of 1.57 Mbps.

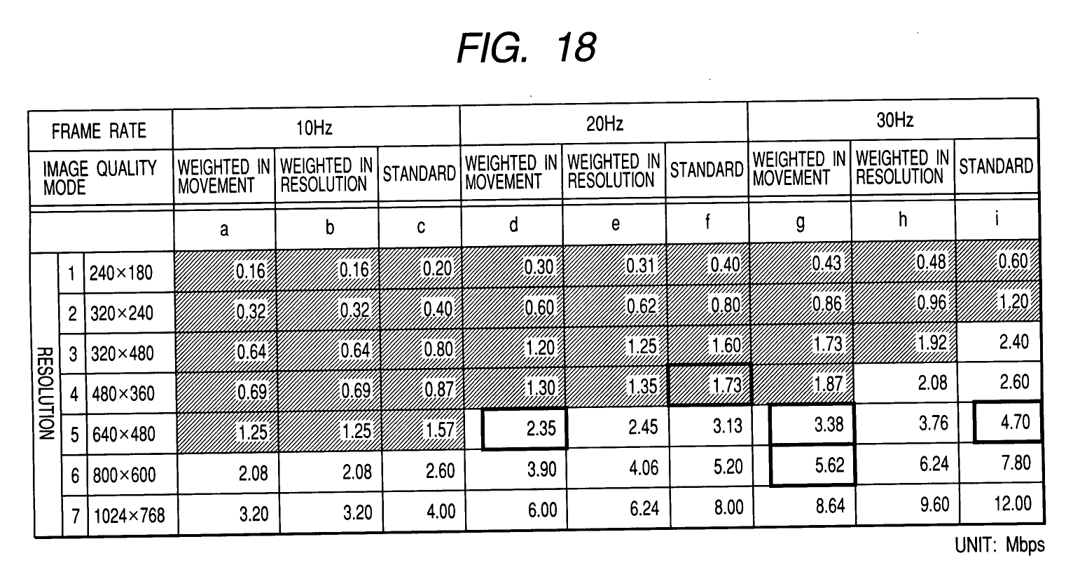

On the other hand, in the transfer mode table of FIG. 17, when a transfer mode having the resolution of 800 pixels×600 pixels and the frame rate of 30 Hz is selected as the provisional requested transfer mode and the processing shown in FIGS. 16A and 16B are executed in the mode weighted in movement, the modes enclosed by quadrilaterals in FIG. 18 indicate the transfer modes which are examined on the way of decision.

In this case, the determination procedure starts from the standard mode 6i having the resolution of 800 pixels×600 pixels similarly to the case weighted in resolution, and the procedure examines the modes in the order of 6i→6g→5i→5g→5f→5d→4f. Finally, the transfer mode is determined to be the transfer mode 4f having the resolution of 480 pixels×360 pixels, the frame rate of 20 Hz, and the transfer speed of 1.73 Mbps.

Hereupon, the transfer mode 5c (having the transfer speed of 1.57 Mbps) determined by the procedure weighted in resolution is selected.

In the above, the following case was described. That is, in the case, the specifications of the display and the limitations owing to the relations to the other displays were considered. Under such consideration, the supreme condition among the transfer modes which could satisfy the image display conditions at a sub-display area specified by the broadcasting side without performing the interpolation processing of received image data was set as a provisional required transfer mode. Then, the transfer mode was gradually lowered until the transfer mode became one having the transfer speed equal to or smaller than the maximum receivable speed (hereupon 2 Mbps) determined on the basis of the specifications of the network and the receiver. However, the following configuration may be also adopted. That is, first the lowest transfer mode having a transfer speed which satisfies the condition specified by the broadcasting station side is set as a provisional required transfer mode. Then, when the transfer speed of the transfer mode meets the maximum receivable speed condition determined on the basis of the specifications of the network and the receiver, the transfer mode is determined to be the final requested transfer mode. In this case also, it is suitable to judge the maximum displayable area of the display and the relation with the other screen.

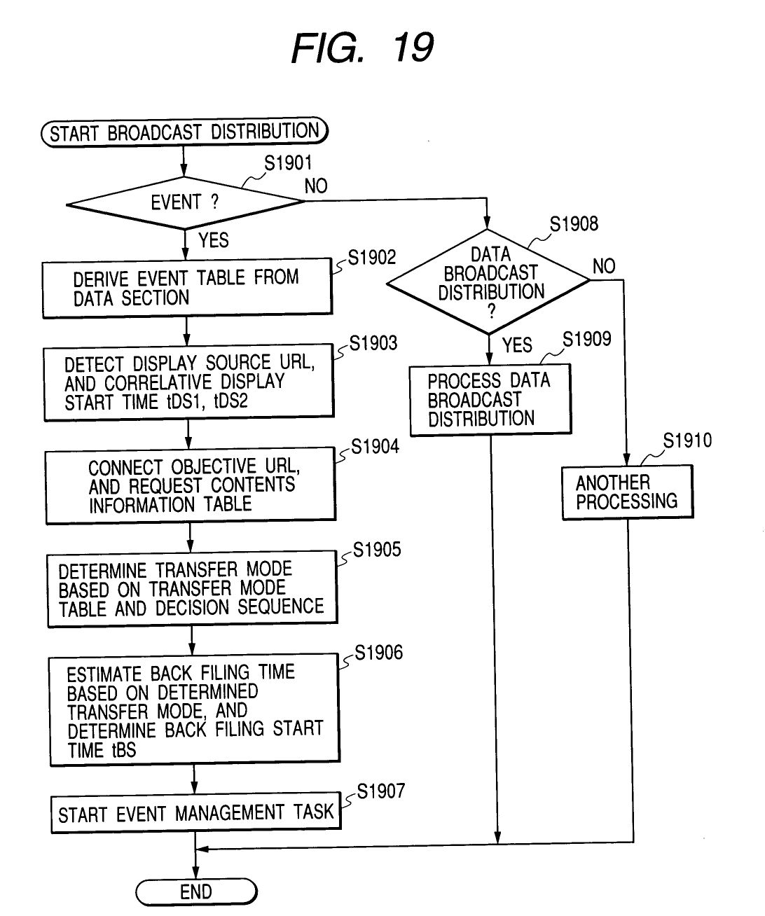

Next, the operation of the system control 112 in the broadcasting management task will be described by means of FIG. 19. The broadcasting management task is a task for examining a program when the program has started, and then for performing the processing other than the ordinary screen displaying processing.

First, when the receiver 100 starts to receive a television broadcast, the system control 112 examines the existence of an event correlated with the broadcast (Step S1901). In the present embodiment, a packet including the event table shown in FIG. 9 or 10 is multiplexed on the received television broadcasting data. The system control 112 examines the existence by confirming the contents of the packet including the event table received from the tuner 102. When there is no event, the system control 112 examines the existence of data broadcast distribution (Step 1908). When there is any data broadcast distribution, the system control 112 processes the data broadcast distribution (Step S1909). When there is no data broadcast distribution, the system control performs other processing (Step S1910). Incidentally, the operation other than that concerning events is not related to the present invention, the details of the operation are omitted.

Moreover, when the existence of an event could be detected at Step S1901, the system control 112 derives the event table of the event from the received data to store the derived event table in the data preservation 114 (Step S1902). The states of the event tables to be derived in the present embodiment are shown in FIGS. 9 and 10.

Then, the system control 112 analyses the contents of the event table stored in the data preservation 114, and recognizes the following (Step S1903). That is, the system control 112 should make the display 106 display the image based on a stream at a URL: www.sbs.co.jp/news090/ieie.rum at a lower right position of the screen of the display 106 in a size equal to 240 pixels×180 pixels or more as a subsidiary screen at the time tDs1. Moreover, the system control 112 should make the display 106 display the image in a size equal to 640 pixels×480 pixels or more at the size ratio of 4.0 or more at the time tDs2.

Next, the system control 112 controls the Internet connector 113 to request the contents information table of the stream at the URL: www.sbs.co.jp/news090/ieie.rum from the stream server S being a transmitter of streams for obtaining the contents information table (Step S1904). The contents information table received hereupon is one shown in FIG. 7. The system control 112 stores the received contents information table in the data preservation 114.

Next, the system control 112 derives the transfer mode table in the contents information table stored in the data preservation 114, and determines the transfer mode in accordance with the transfer mode deciding procedure described by reference to FIGS. 16A and 16B (Step S1905).

In the present embodiment, first, in the broadcasting event 1, the display resolution is 240 pixels×180 pixels or more, and the size ratio to the television broadcast reception screen is 0.25 or less, as shown in FIG. 9. Moreover, the resolution of the display 106 is 1300 pixels×1100 pixels. When these conditions are considered, it is judged to be suitable that the images of the television broadcasting to be displayed on the main screen have the resolution of 800 pixels×600 pixels in the interlace system of 60 Hz, and that the images to be displayed on a subsidiary screen has the resolution of 320 pixels×240 pixels at 30 Hz. The required transfer mode is also similarly determined.

For example, when the transfer mode is determined on the basis of the transfer mode table shown in FIG. 17, the mode 2i is determined as the transfer mode because the mode 2i has the resolution of 320 pixels×240 pixels, the frame rate of 30 Hz and the transfer speed is 1.2 Mbps.

On the other hand, in the display of the broadcasting event 2, the resolution is 640 pixels×480 pixels or more, and the size ratio to the display screen of television broadcasting is 4.0 or more, as shown in FIG. 10. Moreover, the resolution of the display 106 is 1300 pixels×1100 pixels. When these conditions are considered, two cases are considerable. In one of the cases, as shown in FIG. 13, the display screen of the television broadcasting has the resolution of 240 pixels×180, and the display screen of the stream broadcasting has the resolution of 1024 pixels×768 pixels. In the other of the cases, as shown in FIG. 14, the display screen of the television broadcasting has the resolution of 320 pixels×240, and the display screen of the stream broadcasting has the resolution of 800 pixels×600 pixels. However, in the case shown in FIG. 13, the size ratio is 18, which is deviated from 4.0 of the required condition, and the degree of enlargement of image data of the received stream broadcasts by interpolation becomes large. Accordingly, the case shown in FIG. 14 is adopted here. Because the size of the area in which the received stream broadcasts are 800 pixels×600 pixels and the transfer mode meeting the condition of the resolution is unreceivable in consideration of the maximum receivable speed, it is planed to perform the interpolation processing of the received image data. As described above, the mode having the resolution of 640 pixels×480 pixels and the frame rate of 10 Hz is selected as the required transfer mode. The two transfer modes determined as mentioned above are stored in the data preservation 114 as the parameters of the broadcasting events 1 and 2.

Next, the size of the buffer memory 109 is determined on the basis of the determined transfer modes, and buffering time tBuff1, tBuff2 are estimated. Then, the stream buffering start time (reception start time) tBS1, tBS2 is determined as follows (Step S1906) in order that the buffering of the data to the buffering memory 109 may be actually completed at the display switching time tDS1, tDS2 and display can be immediately started.

tBS1=tDS1−tBuff1−tα

tBS2=tDS2−tBuff2−tα

Incidentally, tα is time for allowing the other processing and a margin.

Then, on the basis of the time information from the timer 115, the system control 112 registers the starting of the event 1 task at the time tBS1, the starting of the event 2 task at the time tBS2, and the end of the event 1 task at the time tDS2. Then, the system control 112 starts the event management task, and ends the broadcasting management task processing (Step S1907).

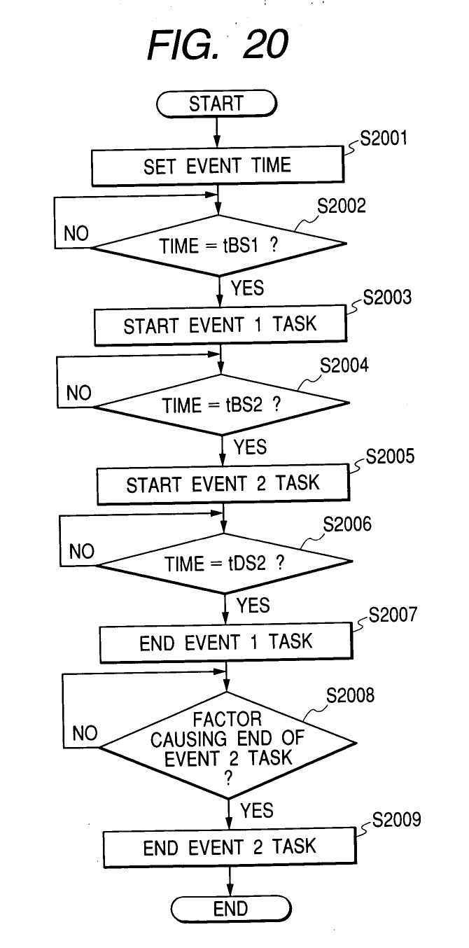

Next, the operation of the event management task will be described by means of the flowchart of FIG. 20.

The event management task is a task for controlling reception and display operation according to the requests of the starting or the ending of events at registered time.

In the present embodiment, the starting of the event 1 task and the starting of the event 2 task are registered to be generated at time tBS1 and tBS2, respectively, and the end of the event 1 task is registered to be generated at time tDS2. In FIG. 20, in conformity of the procedure, the system control 112 sets the generation time of each event (Step S2001). When time becomes tBS1 (Step S2002), the system control 112 starts the event 1 task (Step S2003). When time becomes tBS2 (Step S2004), the system control 112 starts the event 2 task (Step S2005). When time becomes tDS1 (Step S2005), the system control 112 ends the event 1 task (Step S2007).

Then, when the end of the event 2 task is registered owing to the other factors and the conditions are satisfied, the system control 112 ends the event 2 task (Steps S2008 and S2009).

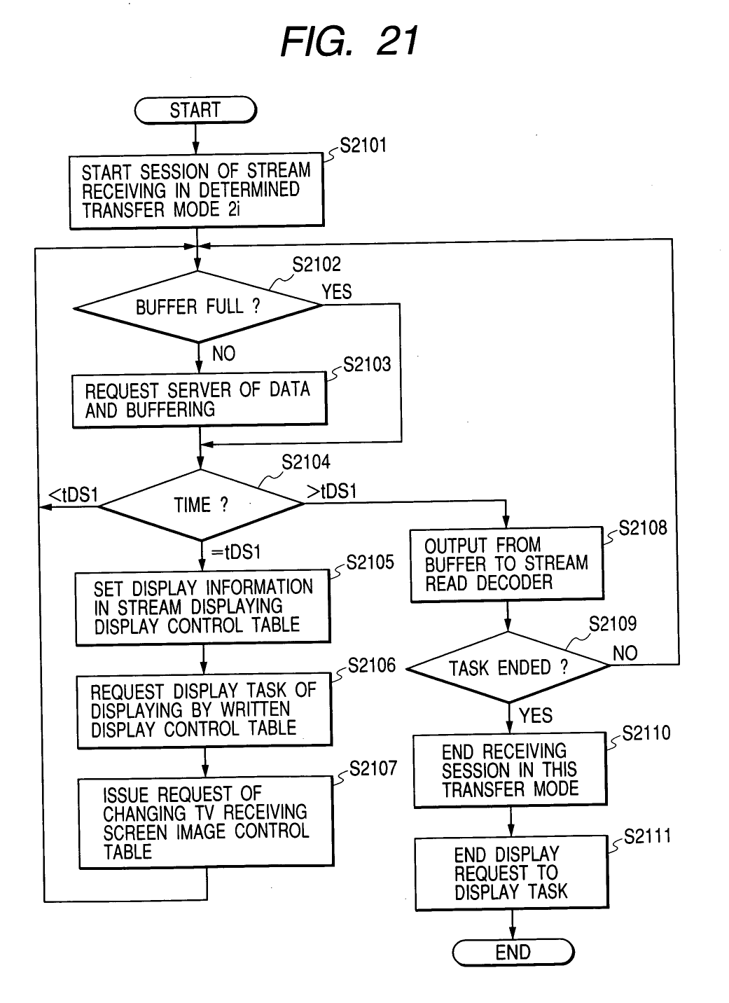

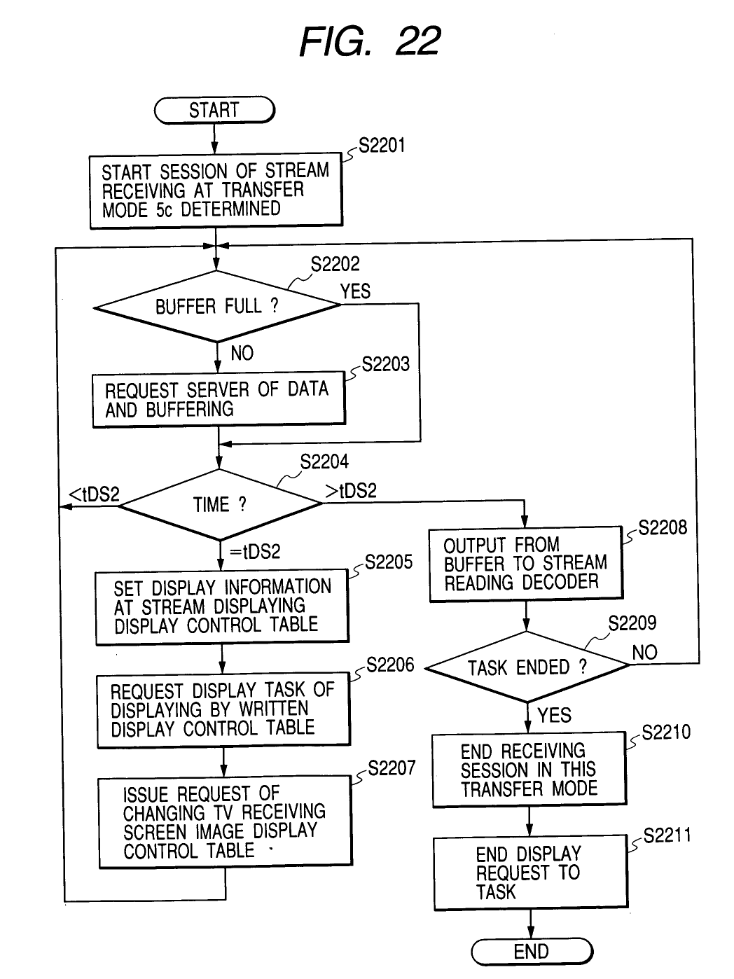

Next, the event 1 task and the event 2 task, which are started by the event management task, will be described by means of the flowcharts of FIGS. 21 and 22.

The event 1 task is a task for receiving the stream at URL: www.sbs.co.jp/news090/ieie.rum to perform the display as shown in FIG. 13 at time tDS1. The event 1 task is started by the event management task at time tBS1.

In the event 1 task, the system control 112 reads the transfer mode determined for the event 1 task, hereupon the mode 2i, from the data preservation 114, and sets the buffer memory 109. Then, the system control 112 starts the session of receiving with the stream server S through the Internet connector 113 (Step S2101).

Next, the system control 112 detects whether a predetermined amount of data is stored in the buffer memory 109 or not (Step S2102). When the predetermined amount of data is not stored, the system control 112 requests the transmission of data from the stream server S, and stores the stream data received from the stream server S in the buffer memory 109 (Step S2103). Then, the system control waits until time tDS1.

When time becomes tDS1, the system control 112 newly generates a display control table, and writes the stream and the information related to the display output which have been determined by the broadcasting management task into the display control table (Step S2105). Then, the system control 112 outputs a display request to the display task (Step S2106). At the same time, the system control 112 outputs to the display task a request for changing the resolution of 1280 pixels×1024 pixels of the display control table used in the display of the present television broadcasting screen to the resolution of 800 pixels×600 pixels (Step S2107).

After that, when it has passed the time tDS1, the system control 112 reads stream data from the buffer memory 109 to output the read stream data to the decoder 110 (Step S2108). Then, the system control 112 examines the existence of a request of ending the task (Step S2109). When no request of ending the task exists, the system control 112 returns to Step S2102, and continues the reception of stream data, buffering and read out. After that, when time becomes tDS2, the event management task generates a request of ending the task. Then, the system control 112 ends the reception of the stream to end the session with the stream server S (Step S2110). Then, the system control 112 transmits the request of ending the display of the stream screen to the display task. Thus, the event 1 task is ended (Step 2111).

Incidentally, the period of time from tBS1 to tDS1 is sufficient for the buffer 109 to output stream data to the decoder 110, and consequently it is possible to perform decoded display immediately in response to the display request to be generated at time tDS1.

Similarly to the event 1 task, the event 2 task is a task for performing the interpolation processing of the stream data transmitted from URL: www.sbs.co.jp/news090/ieie.rum in the transfer mode 5c having the resolution of 640 pixels×480 pixels and the frame rate 10 Hz to perform the display of the stream data as the screen having the resolution of 800 pixels×600 pixels and the frame rate of 30 Hz as shown in FIG. 15 at time tDS2. The event 2 task is started by the event management task at time tBS2.

In the event 2 task, the system control 112 reads the information of the transfer mode determined for the event 2 task, hereupon the mode 5c, from the data preservation 114, and sets the size of the buffer memory 109. Then, the system control 112 starts the session of receiving with the stream server S through the Internet connector 113 (Step S2201). The session is performed independently from the event 1 task.

Next, the system control 112 detects whether a predetermined amount of stream data is stored in the buffer memory 109 or not (Step S2202). When the predetermined amount of the stream data is not stored, the system control 112 requests the transmission of the stream after the time stamp tDS2-tDS1 in the transfer mode 5c from the stream server S, and stores the stream data received from the stream server S in the buffer memory 109 (Step S2203).

Then, the system control waits until the display switching time tDS2 (Step S2204).

Similarly to the event 1 task, the sufficient amount of the stream data for outputting to the decoder 110 can be buffered in the buffer memory 109 until the time tDS2.

After that, when time becomes tDS2, the system control 112 newly generates a display control table, and writes the stream and the information related to the display output which have been determined by the broadcasting management task into the display control table (Step S2205). Then, the system control 112 outputs a display request to the display task (Step S2206). At the same time, the system control 112 outputs to the display task a request for changing the resolution of 800 pixels×600 pixels of the display control table used in the display of the present television broadcasting screen to the resolution of 320 pixels×240 pixels (Step S2207).

Then, when the time becomes tDS2 or after it, the system control 112 reads stream data received at the transfer mode 5c from the buffer memory 109 to output the read stream data to the decoder 110 (Step S2208). After that, the system control 112 examines the existence of a request of ending the task from the event management task (Step S2209). When no request of ending the task exists, the system control 112 returns to Step S2202, and continues the reception of stream data, buffering and read out. Moreover, when the request of the event 2 task is output for the display of other screen display, the end of broadcasting, or the like, the system control 112 ends the reception of the stream to end the session with the stream server S (Step S2210). Then, the system control 112 transmits the request of ending the display of the stream screen to the display task. Thus, the event 2 task is ended (Step 2211).

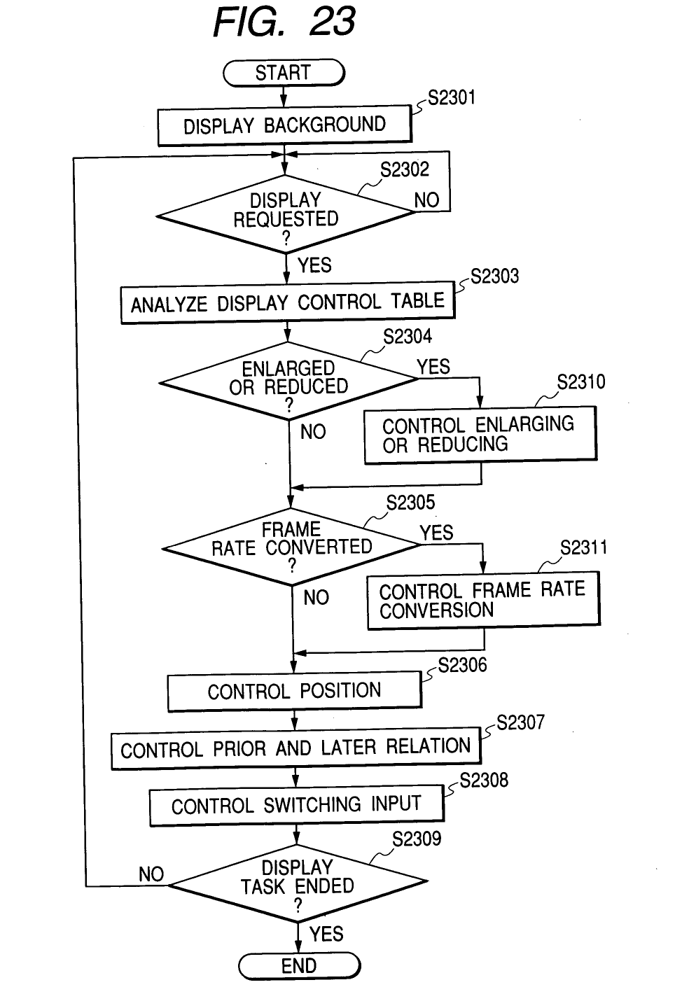

Next, the display task will be described by means of FIG. 23.

The display task is a task for controlling the image converter 104 and the display controller 105 to control display images on the display 106 in response to the display requests from the broadcasting event 1 task, the broadcasting event 2 task, the other television broadcasting display tasks, an on screen display (OSD) task and the like.

The display task is started at the same time of the turning on of the power source of the receiver 100. The display task performs the display control on the basis of the display control table, or while adjusting a plurality of display control tables.

After the turning on of the electric power source, the system control 112 makes the display 106 display a background first, and waits a display request (Steps S2301 and S2302). When a display request is output, the system control 112 analyses the corresponding display control table (Step S2303). Then, when enlargement or reduction processing is necessary on the basis of the analysis result, the system control directs the image converter 104 to perform the enlargement or the reduction processing. Then, the image converter 104 performs the enlargement or the reduction processing (Steps S2304 and S2310). Furthermore, when frame rate conversion is necessary, the system control 112 directs the display controller 105 to perform the frame rate conversion. Then, the display controller 105 performs the frame rate conversion (Steps S2305 and S2311).

Then, the system control 112 controls the display position in the X-Y direction (the up and down direction), the position in the Z direction (the overlapping direction of images) by means of the display controller 105 (Steps S2306 and S2307) to switch the image sources to be displayed on the display 106 (Step S2308). Then, the system control 112 ends the processing of the display task (Step S2309).

In the present embodiment, after the electric source is turned on, the system control 112 generates the display control table for displaying the whole screen in conformity with the display task, and the system control 112 makes the display 106 display the broadcast of the channel selected by a viewer.

In the state, the event 1 task is generated as described above.

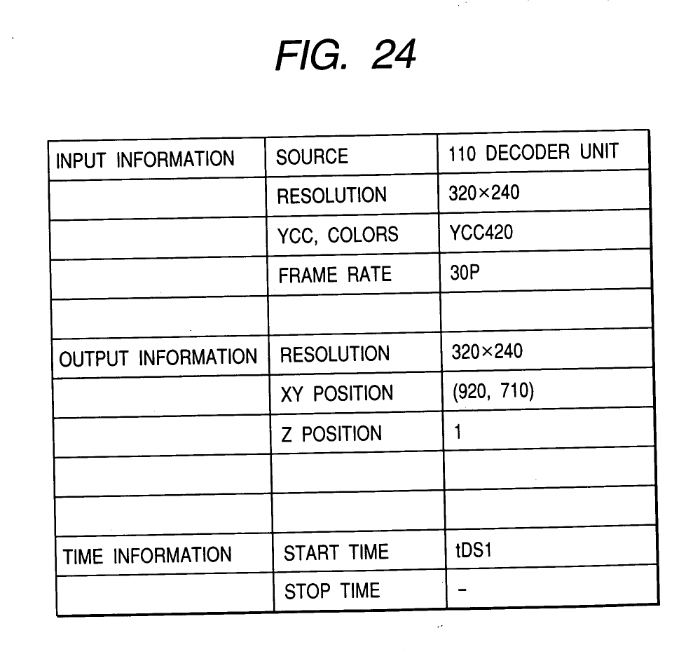

A display control table generated newly in response to the request of the event 1 task in the present embodiment is shown in FIG. 24. As shown in the display control table of FIG. 24, because the size and the frame rate of the stream received at the time of the event 1 task are the same as the size of the display screen of the stream data by the event 1 task and the frame rate of the display 106, respectively, the processing of the enlargement or the reduction of images or the processing of the frame rate conversion becomes unnecessary. In the display control task accompanying the event 1 task, it is sufficient to set the X-Y position information and Z position information, and to set the stream data from the decoder 110 as the video source.

Moreover, as for the display screen of television broadcasts, because the display size is changed to the resolution of 800 pixels×600 pixels, it is necessary to reduce the display size from the original resolution of 1280 pixels×1024 pixels. Then, the display control table is rewritten to the changed size.

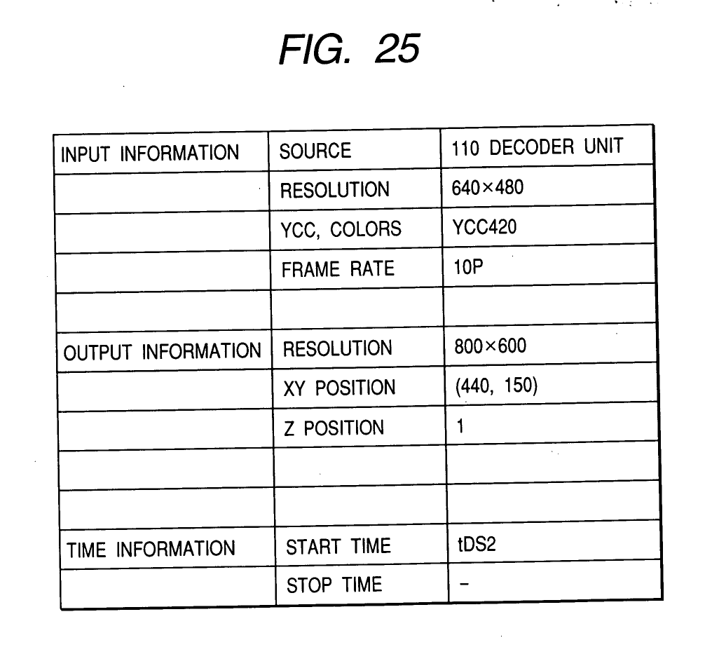

Moreover, a display control table generated newly in response to the request of the event 2 task in the present embodiment is shown in FIG. 25. As shown in the display control table of FIG. 25, because the size and the frame rate of the stream received at the time of the event 2 task are different from the size of the display screen of the stream data by the event 2 task and the frame rate of the display 106, respectively, the screen size is set to be processed to be enlarged by 1.25, and the frame rate is set to be changed by three times. Moreover, it is sufficient to set the X-Y direction and the Z direction, and to set the stream data from the decoder 110 as the video source.

Moreover, as for the display screen of television broadcasts, because the display size is changed to the resolution of 320 pixels×240 pixels, it is necessary to reduce the display size from the original size of the resolution of 1280 pixels×1024 pixels. Then, the display control table is rewritten to the changed size.

As described above, in the present embodiment, when the receiver 100 receives stream broadcasting, the receiver 100 selects the suitable delivery data among a plurality of delivery modes having different resolution and different frame rates from each other according to the size of the display screen in the display 106 and the frame rate of the display 106, and the receiver 100 receives the stream data by the selected delivery mode. Consequently, there is no chance of receiving the stream for an unnecessarily large screen. Hence, the resources of the apparatus and communication paths can be effectively used. Moreover, even if delivery charges are different according to delivery modes, wasteful costs can be reduced.

Moreover, when a delivery mode is selected, the delivery mode is selected in consideration of the limitation of the communication speed, the screen size to be displayed, the frame rate of the display 106 and the like. Consequently, for example as the case of the event 2 task described above, it is possible to perform display almost meeting the display request even if the maximum transfer speed is insufficient.

Moreover, because the receiver does not receive the data exceeding the display ability of the display 106, frame dropping or the like is not produced, and thereby stable display can be performed.

(Second Embodiment)

Next, a second embodiment of the present invention will be described.

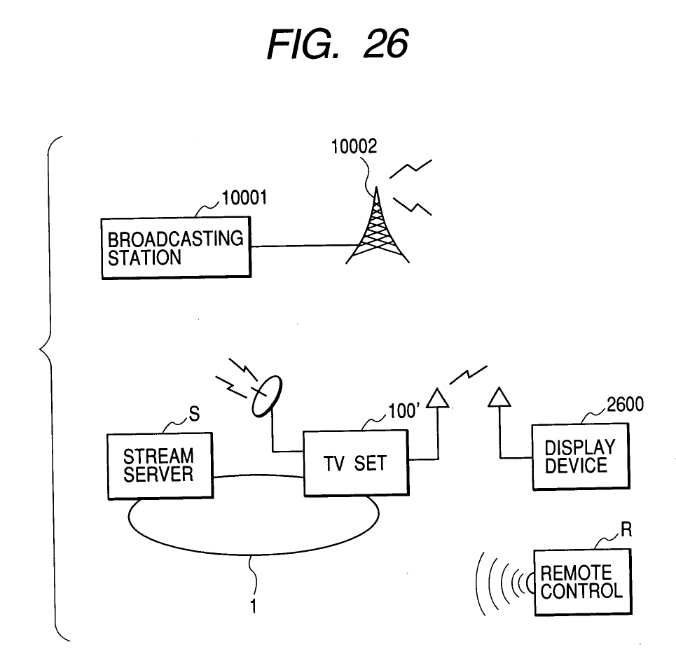

FIG. 26 is a view showing the configuration of the receiving system according to the second embodiment.

In FIG. 26, a television receiver 100′ has almost the same functions as those of the television receiver 100 shown in FIG. 1. Moreover, the television receiver 100 additionally includes the transmission and the reception functions of image data and audio data to the display apparatus 2600.

The reference numeral 2600 designates an apparatus capable of transmitting and receiving image data and audio data by radio from the television receiver 100′. The display apparatus 2600 displays images based on the image data from the television receiver 100′. Moreover, the display apparatus 2600 outputs sounds based on the audio data from the television receiver 100′.

In addition, the remote control R, the stream server S and the Internet I are the same as those in the first embodiment.

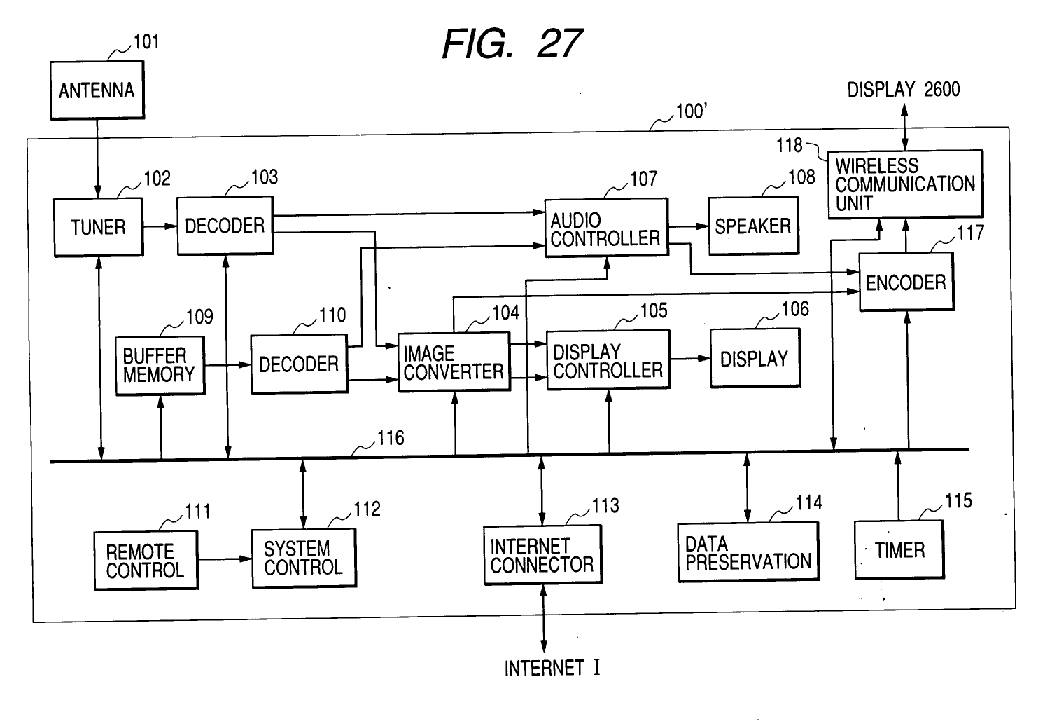

FIG. 27 is a diagram showing the configuration of the television receiver 100′. As shown in FIG. 27, the television receiver 100′ in the present embodiment has almost the same configuration and functions as those of the receiver 100 shown in FIG. 2. However, the configuration of FIG. 27 additionally includes an encoder 117 and a wireless communication unit 118 to the configuration of FIG. 2.

The encoder 118 encodes the image data output from the image converter 104 and the audio data output from the audio controller 107 in accordance with a known compression and coding processing such as the Moving Picture Experts Group phase 2 (MPEG-2) system in the present embodiment. The wireless communication unit 118 converts the image data and audio data which have been encoded by the encoder 117 to the forms suitable to a predetermined standard, and then transmits the converted data to the display apparatus 2600 in addition to the control data of the display apparatus 2600. In the present embodiment, the wireless communication unit 118 performs the transmission and the reception of data in accordance with the IEEE 802.11a standard. The encoder 117 and the wireless communication unit 118 are totally controlled by the system control 112.

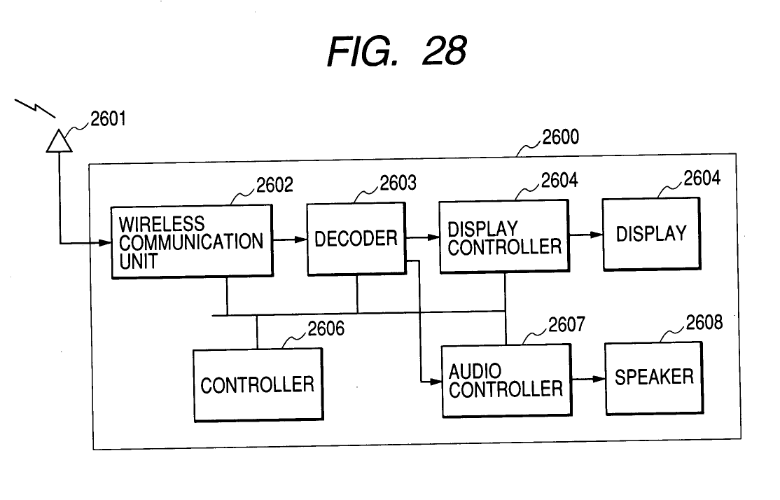

FIG. 28 is a block diagram showing the configuration of the display apparatus 2600.

In FIG. 28, a reference numeral 2602 designates a wireless communication unit. The wireless communication unit 2602 performs the transmission and the reception of data with the television receiver 100′ through an antenna 2601. The wireless communication unit 2602 outputs received image data and audio data to a decoder 2603, and outputs various kinds of control data to a controller 2606. Incidentally, the wireless communication unit 2602 also performs the transmission and the reception of data on the basis of a standard corresponding to the IEEE 802.11a.

The reference numeral 2603 designates the decoder. The decoder 2603 decodes the image data and the audio data which have been received from the wireless communication unit 2602 to output the decoded data to a display controller 2604 and an audio controller 2607. The reference numeral 2604 designates the display controller. The display controller 2604 outputs the image data from the decoder 2603 to a display 2605, and controls the display operation of the display 2605. The reference numeral 2605 designates the display. The display 2605 having the display performance of 640 pixels×480 pixels and the frame rate of 20 Hz.

The reference numeral 2607 designates the audio controller. The audio controller 2607 processes the audio data from the decoder 2603 to control the sound volume, the sound quality, the presence of the audio data, and the like. The audio controller 2607 outputs the audio data to a speaker 2608.

Next, the operation of the present embodiment will be described.

In the present embodiment also, the basic operation thereof is similar to that of the first embodiment. In the following descriptions, the following case will be described. That is, in the case, after the turning on of the electric power source of the receiver 100′, a user operates to display the screen of a television broadcast on the left side of the display 2605, and the screen of a stream broadcasting program from the Internet on the right side of the display 2605. Furthermore, the receiver 100′ transmits the data of the stream broadcast displayed on the right side of the display 2605 to the display apparatus 2600 to display as shown in FIG. 30.

The outline of the operation is as follows.

1. A display task generates a display control table for displaying a television broadcasting screen, and displays the image of the television program on the whole screen as shown in FIG. 11 in response to are display request made to the display task.

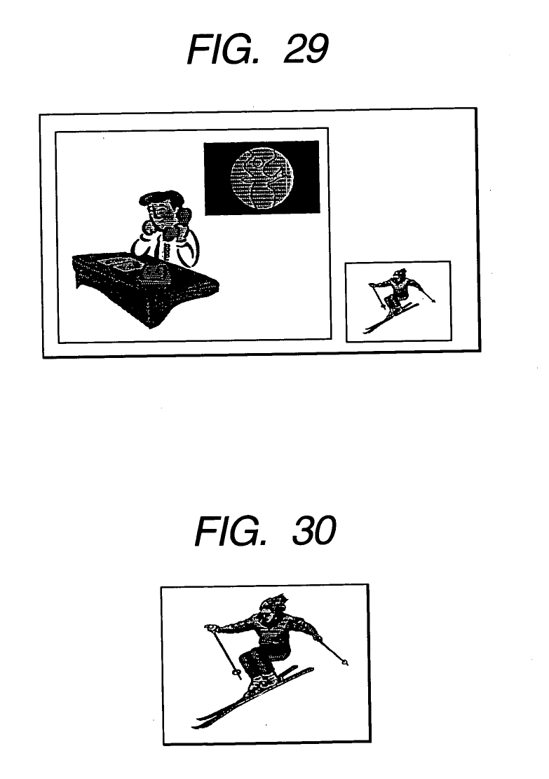

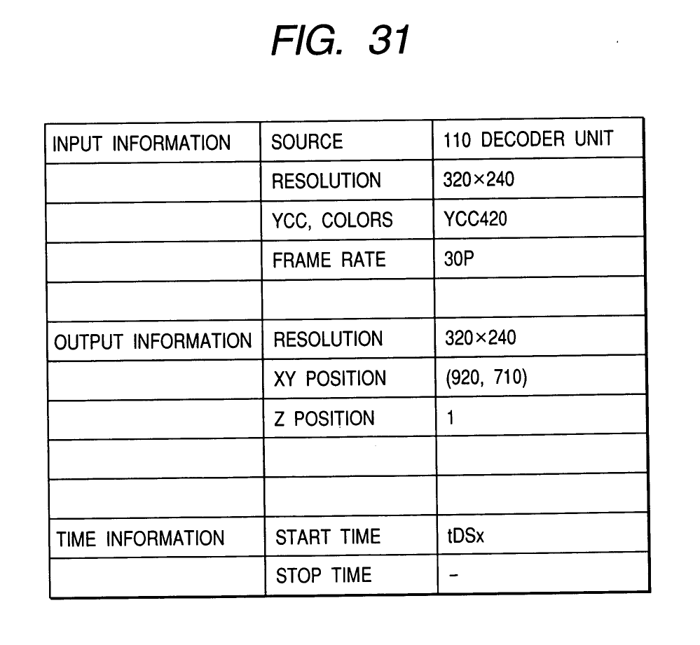

2. When a request for displaying television broadcasting programs in two screens of a parent and a child and a stream broadcasting program is input by a user's operation, a subsidiary screen task is started. In the generated subsidiary screen task, the system control 112 generates a display control table for a subsidiary screen as shown in FIG. 31. Then, the system control 112 request display from the transfer mode display task to display the television broadcasting programs and a stream broadcasting program in two screens as shown in FIG. 29.

Incidentally, in the present embodiment, the contents information table and the transfer table of the stream to be received are supposed to be ones shown in FIGS. 7 and 8 similarly to the first embodiment. Moreover, the display mode of the subsidiary screen shown in FIG. 29 has the resolution of 320 pixels×240 pixels and the frame rate of 30 Hz. The transfer mode 2i is selected as the optimum transfer mode.

3. After that, when the user performs an operation for displaying the stream broadcasting program, which has been viewed in the subsidiary screen of the display 106, on the display apparatus 2600, the system control 112 starts the display apparatus task. Then, the system control 112 starts to receive the stream in the optimum transfer mode for the transmission to the display apparatus 2600, and switches the stream.

Now, the processing of the items 1 and 2 does not matter to the present invention directly, and the detailed description of the processing is omitted.

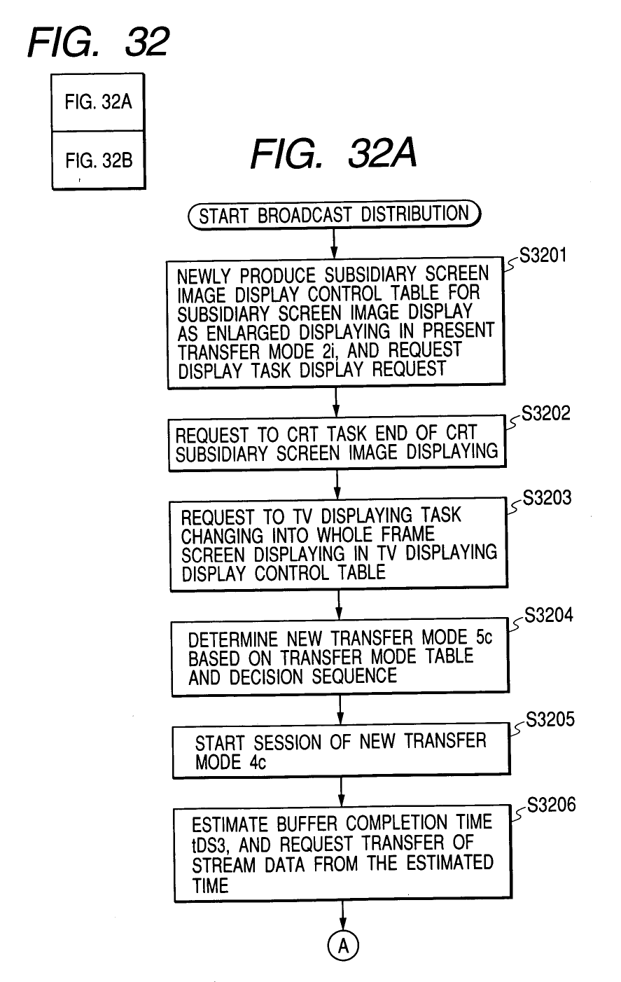

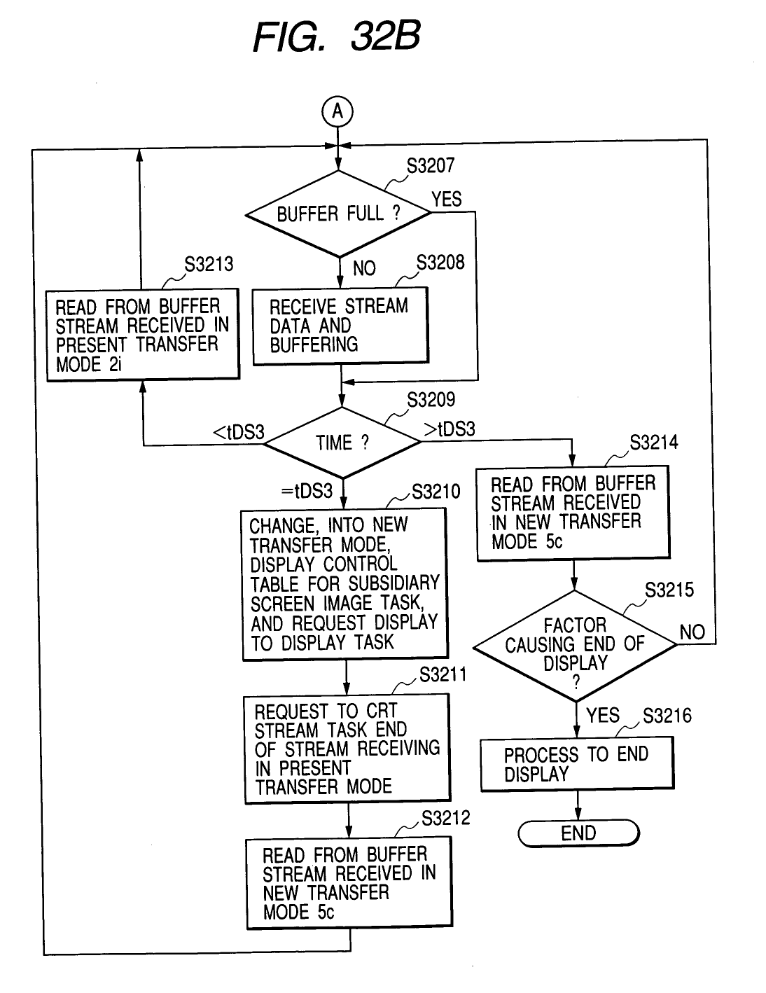

Next, the operation of the item 3 will be described by means of the flowcharts of FIGS. 32A and 32B.

When the user operates the remote control R to direct the display of the stream broadcasting program shown in FIG. 29 on the display apparatus 2600, the system control 112 of the receiver 100′ newly generates a display control table for the display apparatus 2600. Then, the system control 112 requests the enlarged displaying on the display apparatus 2600 from the display task by means of the present transfer mode 2i as the source (Step S3201). Then, the system control 112 request to end the display of the subsidiary screen display task of the display 106 (Step S3202). Moreover, the system control 112 requests the changing of the television broadcasting program into the whole frame screen displaying on the display 106 from the display task (Step S3203).

At this point of time, the display screen of the display 106 of the receiver 100′ changes to the screen of FIG. 11, and the stream broadcasting program which has been displayed in the small screen of FIG. 29 is displayed by being enlarged as shown in FIG. 30 on the display 2605 of the display apparatus 2600.

Next, the optimum transfer mode of the displaying in the display apparatus 2600 is determined by a procedure similar to the one of the first embodiment. In the present embodiment, the display 2605 is an LCD, and the resolution is 640 pixels×480 pixels, and further the frame rate is 20 Hz. The LCD is rough in dot pitches in comparison with the ones of the CRT, and consequently, the deterioration of images by enlargement is conspicuous. Moreover, the LCD is slow in response speed, and consequently a low frame rate would not weigh on the user's mind. The two points are considered, and then the required transfer mode is set to have the resolution of 640 pixels×480 pixels and the frame rate of 20 Hz. Furthermore, the selection procedure is set to be one weighted in resolution. When the optimum transfer mode is determined on the assumption mentioned above, the optimum transfer mode starting from 5f in FIG. 8 is determined to be 5c similarly to the first embodiment (Step S3204).

Then, the system control 112 starts a session for stream reception in the transfer mode 5c (Step S3205). At the same time, the system control 112 estimates the reception buffer size and the buffering estimation time tBuff3.

Then, the system control 112 detects the time stamp tNOW of the latest packet in the receiving stream in the present mode 2i to determine time tDS3=tNOW+tBuff3+tα as the display switching time. The system control requests the stream packets from the time tDS3 of the stream server S, and starts to receive the stream packets (Step S3206).

Then, the system control 112 continues the buffering of the stream data until the time becomes the display switching time tDS3 (the system control 112 temporarily stops the buffering at the time when a predetermined amount of data is stored in the buffer memory 109 on the way) (Steps S3207, S3208 and S3213).

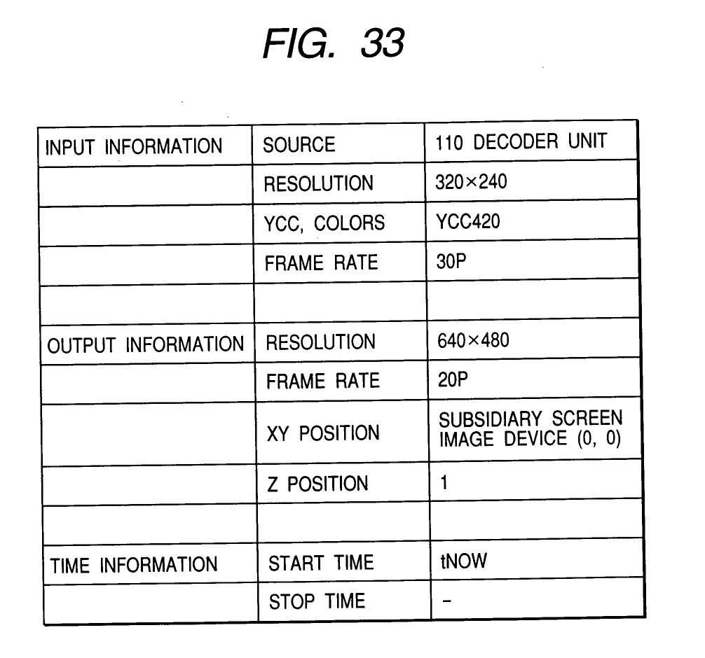

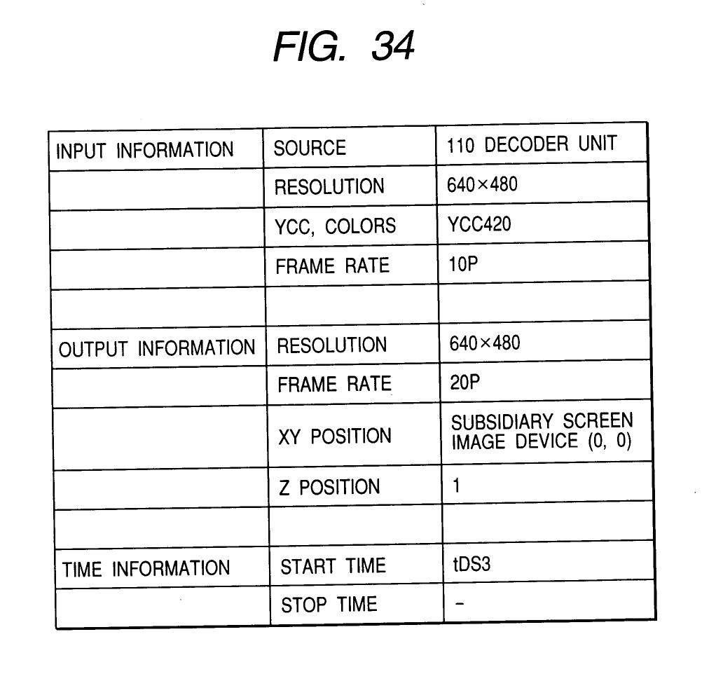

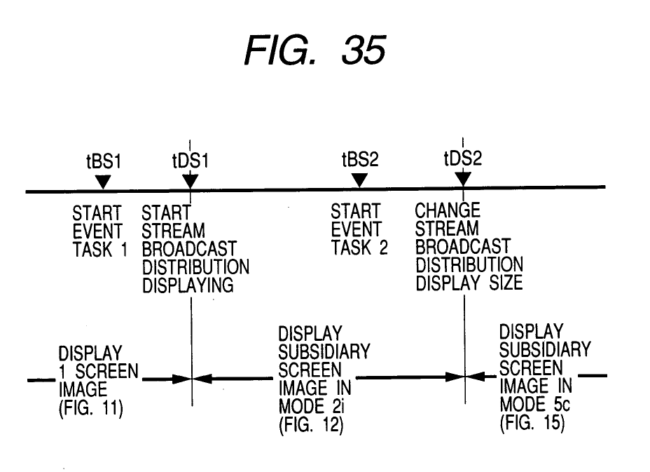

When time becomes tDS3 (Step S3209), the system control 112 changes the display control table for the display apparatus from the one shown in FIG. 33 to the one shown in FIG. 34 (Step S3210). Then, the system control 112 issues the request of the end of the stream receiving session in the present transfer mode 2i to the subsidiary display task of the display 106 (Step S3211), and starts to read streams from the receiving buffer in the new transfer mode 5c (Step S3212).

After the time tDS3, the system control 112 reads the data received in the new transfer mode 5c from the buffer memory 10 (Step S3214). If there is no request of ending the display apparatus task, the system control 112 continues the reception and the reading (Step S3215). On the other hand, the display task which has received a display request to the display apparatus 2600 controls the image converter 104, the display controller 105, the audio controller 107, the encoder 117 and the wireless communication unit 118 on the basis of each display control table to control the display processing on the display 106 and the transmission of data to the display apparatus 2600.

Incidentally, as to the display task, the processing similar to that of FIG. 23, which has been described in connection to the first embodiment, is performed.

As described above, when the present embodiment receives a stream broadcast to transmit the received stream broadcast to the external display apparatus, the present embodiment receives the stream broadcast after selecting the optimum delivery mode corresponding to the resolution and the frame rate of the external display apparatus. It is possible to use the resources and the communication paths of the apparatus effectively to the external display apparatus. Moreover, when the delivery charge differs according to the delivery modes, the wasteful costs can be reduced.

As described above, according to the present invention, a suitable receiving apparatus, a suitable image display system and a suitable broadcasting method can be realized.

What is claimed is:

1. A receiving apparatus, comprising:
a reception circuit for receiving image data transmitted through a network;
an output circuit for outputting the image data received by said reception circuit to a display apparatus; and
a control circuit for generating a signal for requesting an apparatus for controlling the transmission, to transmit the image data in a transmission mode according to a size of a display area in which an image based on the image data is displayed.

2. A receiving apparatus according to claim 1, wherein said control circuit selects the transmission mode from a plurality of transmission modes having different transmission speeds, and generates a signal for requesting transmitting the image data in the selected transmission mode.

3. A receiving apparatus according to claim 2, wherein said control circuit selects from the plurality of transmission modes a transmission mode having a transmission speed lower than that of a maximum reception speed, in which said reception circuit can receive through said network.

4. A receiving apparatus according to claim 2, wherein the image data includes data for displaying a series of images, and the plurality of transfer modes includes at least a plurality of transfer modes in which frame rates of the series of images are different from each other.

5. A receiving apparatus according to claim 2, wherein the plurality of transfer modes includes a first mode and a second mode, the first mode being a mode in which resolution of an image to be displayed on a basis of data transmitted in the first mode is recognized to be higher than resolution of an image to be displayed on a basis of data transmitted in the second mode.

6. A receiving apparatus according to claim 2, wherein the image data includes data for displaying a series of images, and the plurality of transfer modes includes a first mode and a second mode, the second mode being a mode in which visibility of a movement of an object in a series of images displayed on a basis of data transmitted in the second mode is higher than visibility of a movement of an object in a series of images displayed on a basis of data transmitted in the first mode.

7. A receiving apparatus according to claim 2, wherein said reception circuit receives transmission mode information including at least information of a plurality of transmission modes which an apparatus for performing transmission of the image data can transmit.

8. A receiving apparatus according to claim 1, wherein said output circuit includes a buffer memory for storing the image data received by said reception circuit, and changes an amount of data to be stored in said buffer memory according to the transmission mode in which the transmission is requested to be performed.

9. A receiving apparatus according to claim 1, wherein said reception circuit receives a signal specifying the size of the display area in which the image based on the image data is displayed.

10. A receiving apparatus according to claim 1, wherein said control circuit performs control in order that images may be displayed in a plurality of display areas severally, the display areas including at least a first display area being the display area in which the image based on the image data is displayed and a second display area different from the first display area, a size of said first display area determined on a basis of designation made by a transmitter of image data for displaying an image in the second display area.

11. A receiving apparatus according to claim 1, wherein said control circuit performs control in order that images may be displayed in a plurality of display areas severally, the display areas including at least a first display area being the display area in which the image based on the image data is displayed and a second display area different from the first display area, and the image data for displaying the image in the first display area is image data specified by a transmitter of image data for displaying an image in the second display area.

12. A receiving apparatus according to claim 10, wherein said receiving apparatus displays a television broadcast in the second display area.

13. A receiving apparatus according to claim 1, wherein said reception circuit receives information related to time when the size of the display area in which the image is displayed is changed, and said control circuit changes the transmission mode requested to said apparatus for controlling the transmission on a basis of the information related to the time.

14. A receiving apparatus according to claim 1, wherein said receiving apparatus has the display apparatus built-in.

15. A receiving apparatus, comprising:
a reception circuit for receiving first image data for displaying an image in a first display area in a maximum display area of a display apparatus, second image data for displaying an image in a second display area in the display area, and an information related to image displaying in the first display area; and
a control circuit for generating a signal for requesting an apparatus for controlling the transmission of the first image data, to transmit the first image data on a basis of the information, wherein the information is specified by a transmitter of the second image data.

16. A receiving apparatus according to claim 15, wherein the information includes at least information indicating a size of the first display area.

17. A receiving apparatus according to claim 15, wherein the first image data is data for displaying a series of images, and the information includes at least information indicating a frame rate of the series of images.

18. A receiving apparatus according to claim 15, wherein the information includes at least information specifying the first image data.

19. A receiving apparatus according to claim 15, wherein the information includes at least information related to time to start or to end displaying based in the first image data.

20. A receiving apparatus according to claim 15, wherein the information includes at least information related to time when a size of the first display area is changed.

21. A receiving apparatus according to claim 15, wherein the first image data and the second image data are received by the receiving apparatus through different paths.

22. An image display system comprising a receiving apparatus according to claim 1 and a transmission apparatus for transmitting at least one of pieces of the image data.

23. An image display system comprising a receiving apparatus according to claim 15 and a transmission apparatus for transmitting at least one of the image data.

24. A broadcasting method for broadcasting a program to a receiving apparatus, comprising the steps of:
transmitting the program in order that the receiving apparatus can receive the program; and
transmitting information for displaying an image related to the program as a display screen different from a display screen in which a display apparatus for displaying the program displays the program.

25. A broadcasting method according to claim 24, wherein the information includes at least information for specifying image data for displaying the image related to the program.

26. A broad casting method according to claim 24, wherein the information includes at least information for specifying a displaying size of the image related to the program with said display apparatus.

27. A broadcasting method according to claim 24, wherein the information includes at least information related to time to start or to end displaying of the image related to the program.
